(19) United States
(12) Patent Application Publication
(10) Pub. No.: US 2024/0354772 A1
(43) Pub. Date: Oct. 24, 2024

(54) SYSTEMS AND METHODS FOR DYNAMICALLY IDENTIFYING AND ANALYZING EMERGING TOPICS WITHIN TEMPORALLY BOUND COMMUNICATIONS

(71) Applicant: Wells Fargo Bank, N.A., San Francisco, CA (US)

(72) Inventors: Kevin Portis, San Pedro, CA (US); Dane Arnesen, St. Louis Park, MN (US); Dion Song, Eden Prairie, MN (US)

(21) Appl. No.: 18/304,971

(22) Filed: Apr. 21, 2023

(51) Int. Cl. G06Q 30/015; G06F 40/20; G06Q 10/0631

(52) U.S. Cl. CPC G06Q 30/015; G06F 40/20; G06Q 10/06311

(57) ABSTRACT

Systems, apparatuses, methods, and computer program products are disclosed for generating an insight report. An example method includes receiving a configured input data set and selecting an insight engine configuration based on a configuration parameter set. The method further includes generating a n-gram term set and performing a streamline n-gram routine on the n-gram term set. The method further includes generating an emerging topic set for an interest population and generating a per-topic metric set for each topic identifier included in the emerging topic set. The method further includes generating an insight report which comprises each per-topic metric set and providing the insight report.

### BACKGROUND

Many institutions and other entities receive large volumes of communications from users. These communications may convey or involve various topics of interest that may be of importance to the institution. Furthermore, these topics of interest may be time-sensitive and in some instances, may require a time-sensitive response from the entity to address potential problems or issues related to the topic.

### BRIEF SUMMARY

As described above, entities may receive large volumes of communications from its users. Individually, these communications may relate to a particular user and/or issue the user is experiencing. However, when considered in aggregate, these communications may reveal that a larger subset of users are experiencing a same issue, which may be indicative of a larger systematic issue that should be addressed. Additionally, these communications are also time-sensitive in nature and thus require a timely analysis to detect a currently ongoing issue such that corrective action can be taken in a timely manner to resolve the currently impacted users and/or proactive action can be taken to prevent other users from experiencing this issue.

Conventionally, evaluation of these communications has been done manually using entity personnel (e.g., employees, administrators, or the like), who may be tasked with manually evaluating individual communications and then addressing these issues at the individual level. While certain techniques (e.g., speech-to-text (STT), optical character recognition (OCR), etc.) may aid entity personnel in their evaluation, this evaluation method still requires a large manual review component such that these conventional techniques are resource intensive. Furthermore, this conventional way of communication evaluation fails to consider the communications in aggregate, and as such fail to discern underlying problems and/or issues that a larger volume of users are experiencing within a particular time frame.

In contrast to these conventional techniques for communication evaluation, example embodiments described herein address the above shortcomings using an insight analytics system that may use an insight engine to process documents (e.g., communications) of a source document set and generate an insight report which includes an emerging topic set generated for an interest population. The insight engine may automatically identify documents within the source document set that pertain to an interest population (e.g., communications occurring within a certain time frame and/or pertaining to certain types of users) and additionally may identify documents within the source document set that pertain to a reference population (e.g., communications occurring within a certain time frame and/or pertaining to certain types of users that is less restrictive than the interest population). The insight engine may then generate a n-gram set based on n-gram terms that are identified within the interest population document set and then evaluate the relative significance of the n-gram terms within the interest population document set using a streamline n-gram routine. The streamline n-gram routine may compare various metrics of the n-gram term occurrence in an interest population as compared to a reference population, which may be used as a baseline, such that the significant n-gram terms may be identified within the interest population. Additionally, the streamline n-gram routine may perform deduplication and/or correlation analysis on the n-gram terms that result in n-gram terms being combined into n-gram pairs and/or n-gram pair combinations. The insight engine may then generate topic identifiers for the n-gram terms, n-gram pairs, and/or n-gram pair combinations, and further generate an emerging topic set which includes the generated topic identifiers. The insight engine may then generate per-topic metric set for each topic identifier indicative of a metrics related to each topic identifier and its associated n-gram terms. The insight engine may then generate an insight report which includes the per-topic metric set for each topic identifier and the insight report may then be provided to one or more entity personnel. The insight engine may further list the topic identifiers based on an inferred significance (e.g., topic ratio lift) for each topic identifier such that topic identifiers determined to be the relatively more prevalent or significant in the interest population are presented first. As such, the entity personnel may be able to review the insight engine and determine appropriate corrective action to take to address possible issues indicated by the topic identifier in a time-efficient manner. Additionally, the entity personnel may be able to quickly discern the most pressing issues for an interest population at a glance as the insight engine has determined a topic ratio lift for each topic identifier and orders the topic identifiers based on this topic ratio lift.

Accordingly, the present disclosure sets forth systems, methods, and apparatuses that may process documents (e.g., communications) pertaining to users of an entity in a time-efficient manner and further, allows for communications to be considered in aggregate such that issues affecting a population of interest may be identified. Additionally, embodiments described herein include filtering, deduplication, and/or combinational operations at various stages of the process such that operational resources may be conserved, and future computational processing burdens reduced. By automating this aggregate communication analysis that has historically required human analysis, the speed and consistency of the evaluations performed by example embodiments unlocks many potential new functions that have historically not been available, such as the ability to conduct near-real-time emerging issue evaluation and resolution.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to generate an insight report for an entity, in accordance with some example embodiments described herein.

FIG. 2 illustrates a schematic block diagram of example circuitry embodying a system device that may perform various operations in accordance with some example embodiments described herein.

FIG. 3 illustrates an example flowchart for generating and providing an insight report for an entity, in accordance with some example embodiments described herein.

FIG. 4 illustrates an example flowchart for determining a n-gram ratio lift and weighted n-gram ratio lift for each n-gram term in a n-gram term set, in accordance with some example embodiments described herein.

FIG. 5 illustrates an example flowchart for generating a n-gram term payload, in accordance with some example embodiments described herein.

FIG. 6 illustrates an example flowchart for determining a n-gram pair lift and n-gram pair confidence lift for each n-gram pair in a n-gram pair set, in accordance with some example embodiments described herein.

FIG. 7 illustrates an example flowchart for generating a n-gram pair payload, in accordance with some example embodiments described herein.

FIGS. 8A-8B illustrate an example flowchart for generating topics identifiers which are associated with one or more n-gram terms, in accordance with some example embodiments described herein.

FIG. 9 illustrates an example flowchart for determining a ratio lift for each topic in an emerging topic set, in accordance with some example embodiments described herein.

FIG. 10 illustrates an example flowchart generating one or more topic context snippets and/or documents for each topic in the emerging topic set, in accordance with some example embodiments described herein.

FIG. 11 provides an operational example of an insight engine workflow in accordance with at least one example embodiment of the present invention.

FIG. 12 provides an operational example of a configuration parameter set of the configured input data set in accordance with at least one example embodiment of the present invention.

FIG. 13 provides another process workflow of a configured insight engine configured to generate an insight report in accordance with at least one example embodiment of the present invention.

FIG. 14 provides a 0_0_n-gram_processing sub-workflow in accordance with at least one example embodiment of the present invention.

FIG. 15 provides a 0_dedup_and_filter sub-workflow in accordance with at least one example embodiment of the present invention.

FIG. 16 provides a 1_children sub-workflow in accordance with at least one example embodiment of the present invention.

FIG. 17 provides a 2_topic_grouping_recollab sub-workflow in accordance with at least one example embodiment of the present invention.

FIG. 18 provides a 3_logic_queries sub-workflow in accordance with at least one example embodiment of the present invention.

FIG. 19 provides a 4_parent_metrics sub-workflow in accordance with at least one example embodiment of the present invention.

FIG. 20 provides a 5_snippets sub-workflow in accordance with at least one example embodiment of the present invention.

FIG. 21 provides a 6_1_final_engine_staging sub-workflow in accordance with at least one example embodiment of the present invention.

FIG. 22 provides a 6_export sub-workflow in accordance with at least one example embodiment of the present invention.

FIG. 23 provides a 7_de_dup_check sub-workflow in accordance with at least one example embodiment of the present invention.

FIG. 24 illustrates an example insight report used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “configured input data set” may refer to a data structure configured to describe a configuration for an insight engine and/or a type of insight report to generate. The configured input data set may describe the configuration for the insight engine and/or type of insight report to generate using a configuration parameter set. The configuration parameter set may include one or more configuration parameters as configured by one or more users. In some embodiments, one or more of the configuration parameters may be configured in a default configuration parameter setting (e.g., set as default value) that a user may change. The one or more configuration parameters may additionally describe an insight engine run type, which may cause an insight engine to select a corresponding configuration that matches the insight engine run type. Additionally, the one or more configuration parameters may describe interest population criteria and, in some embodiments, reference population criteria. As such, an insight engine may be configured to determine an interest population and/or reference population based on the interest population criteria and reference population criteria, respectively. In some embodiments, the one or more configuration parameters may further describe one or more filters to apply to generated data (e.g., n-gram terms, n-gram pairs, etc.).

The configured input data set may further include a source document set which includes one or more documents for processing. In some embodiments, the configured input data set may include a link or location of where documents included in the source document set are currently stored such that the documents themselves are not included in the configured input data set but may be accessed using the described location. The source document set may include one or more documents to be analyzed by the insight engine. The source document set may include a variety of document types including but not limited to phone transcripts, emails, virtual chats, surveys, etc. The documents included in the source document set may be pre-processed such that the characters included within the documents are transformed into machine-readable language. The documents may be pre-processed using any suitable techniques (e.g., optical character recognition (OCR), computer vision, etc.).

The term “n-gram term set” may refer to a data structure configured to store and/or maintain one or more n-gram terms which are identified based on a source document set. In some embodiments, the n-gram term set may include n-gram terms determined or identified within documents of an interest population document subset. A n-gram term may describe a continuous sequence of n items (e.g., words, symbols, tokens, etc.) found within a document (e.g., a document of a source document set and/or interest population document subset). The number n items included in a n-gram term included in the n-gram term set may vary and may be based on a configuration parameter set and/or insight engine configuration. For example, a n-gram term may only include 1 item (e.g., a unigram), 2 items (e.g., a bigram), or 3 items (e.g., a trigram). The n-gram terms included in the n-gram term set may include n-gram terms with the same number of n items or a different number of n items. For example, the n-gram term set may include only bigram terms or may include unigram, bigram, and/or trigram terms. In some embodiments, the n-gram term set may be generated using a stop-word repository. The stop-word repository may store a list of terms, words, symbols, tokens, etc. which describe terms to ignore such that these terms are not included as a n-gram term. The stop-word repository may thus eliminate insignificant terms such as fillers, articles, or the like that may commonly occur but are not considered useful n-gram terms.

The term “emerging topic set” may refer to a data structure configured to store and/or maintain one or more topics generated for a configured input data set. The emerging topic set may include one or more topics that are determined to satisfy one or more topic thresholds. Additionally, each topic may be associated with one or more n-gram terms of the n-gram term set. Each topic included within the emerging topic set may relate to the interest population and furthermore, each topic may be determined to be of significance to the interest population. In some embodiments, a topic dictionary may store and maintain a list of topics generated from previously run or executed configured input data sets. In some embodiments, the topic dictionary may include a topic description, that may be generated by a subject matter expert (SME) or other authorized entity personnel. Additionally, a topic dictionary may store historical metrics related to historically identified topics.

### System Architecture

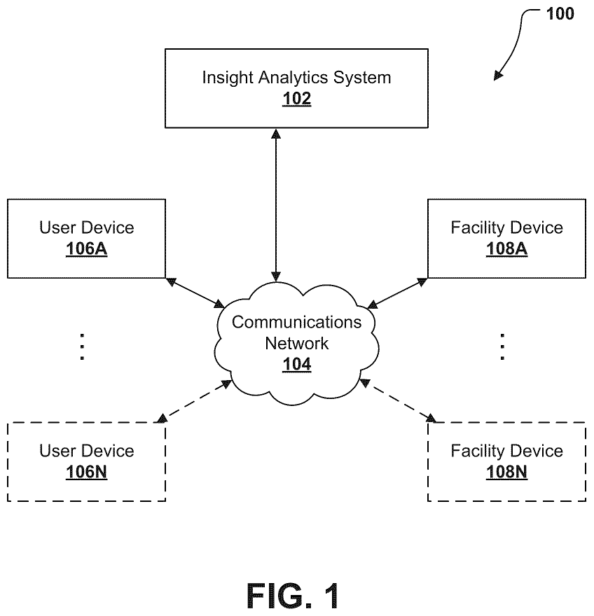

Example embodiments described herein may be implemented using any of a variety of computing devices or servers. To this end, FIG. 1 illustrates an example environment 100 within which various embodiments may operate. As illustrated, an insight analytics system 102 may receive and/or transmit information via communications network 104 (e.g., the Internet) with any number of other devices, such as one or more of user devices 106A-106N and/or facility devices 108A-108N.

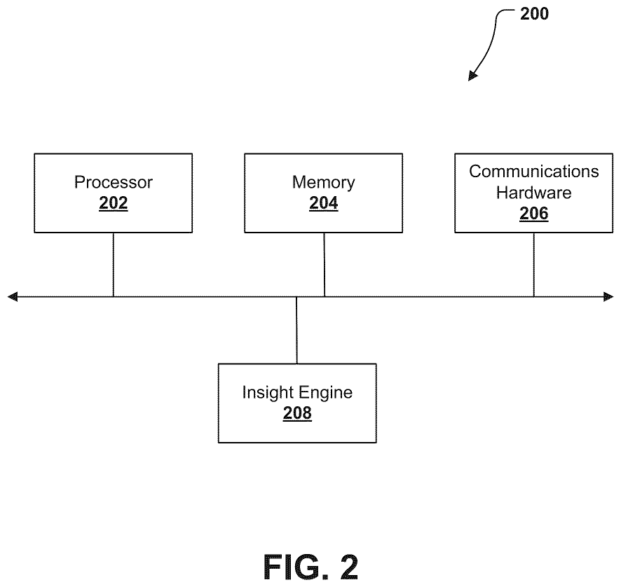

The insight analytics system 102 may be implemented as one or more computing devices or servers, which may be composed of a series of components. Particular components of the insight analytics system 102 are described in greater detail below with reference to apparatus 200 in connection with FIG. 2.

In some embodiments, the insight analytics system 102 further includes a storage device 110 that comprises a distinct component from other components of the insight analytics system 102. A storage device (not shown) may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the insight analytics system 102. The storage device may store information relied upon during operation of the insight analytics system 102, such as various insight engine configurations, n-gram term sets, n-gram pair sets, emerging topic sets, topic dictionaries, or the like that may be used by the insight analytics system 102, data and documents to be analyzed using the insight analytics system 102, or the like. In addition, the storage device may store control signals, device characteristics, and access credentials enabling interaction between the insight analytics system 102 and one or more of the user devices 106A-106N or facility devices 108A-108N.

The one or more user devices 106A-106N and the one or more facility devices 108A-108N may be embodied by any computing devices known in the art. The one or more user devices 106A-106N and the one or more facility devices 108A-108N need not themselves be independent devices, but may be peripheral devices communicatively coupled to other computing devices. In some embodiments, the one or more user devices 106A-106N are associated with users of an entity (e.g., customers). In some embodiments, the one or more facility devices 108A-108N are associated with entity personnel (e.g., employees, contractors, administrators, etc.)

Although FIG. 1 illustrates an environment and implementation in which the insight analytics system 102 interacts indirectly with entity users and/or entity personnel via one or more of user devices 106A-106N and/or facility devices 108A-108N, in some embodiments users may directly interact with the insight analytics system 102 (e.g., via communications hardware of the insight analytics system 102), in which case a separate user devices 106A-106N and/or facility devices 108A-108N may not be utilized. Whether by way of direct interaction or indirect interaction via another device, a user may communicate with, operate, control, modify, or otherwise interact with the insight analytics system 102 to perform the various functions and achieve the various benefits described herein.

### Example Implementing Apparatuses

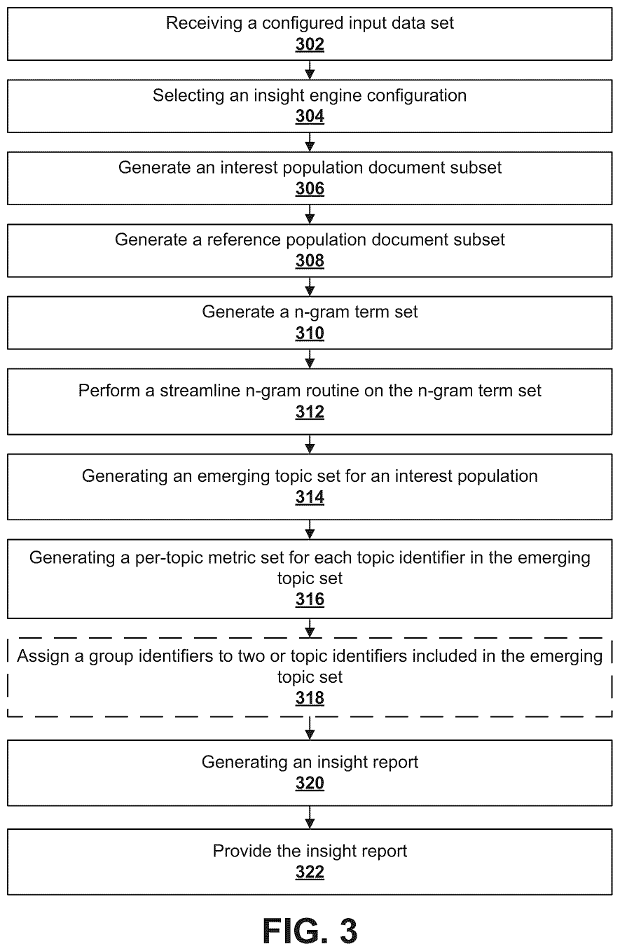

The insight analytics system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-24B. As illustrated in FIG. 2, the apparatus 200 may include processor 202, memory 204, communications hardware 206, and insight engine 208, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in any number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an insight engine 208 that may be configured to receive a configured input data set, select an insight engine configuration, determine a n-gram term set, generate an emerging topic set for an interest population, generate a per-topic metric set for each topic, and generate and provide an insight report. The insight engine 208 may utilize processor 202, memory 204, or any other hardware component included in the apparatus 200 to perform these operations, as described in connection with FIGS. 3-24B below. The insight engine 208 may further utilize communications hardware 206 to gather data from a variety of sources (e.g., user device 106A through user device 106N, facility device 108A through 108N, or a storage device), and/or exchange data with users. In some embodiments, the insight engine may utilize processor 202 and/or memory 204 to perform the above operations and below described operations.

Although components 202-208 are described in part using functional language, it will be understood that the particular implementations necessarily include the use of particular hardware. It should also be understood that certain of these components 202-208 may include similar or common hardware. For example, the insight engine 208 may at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the insight engine 208 may leverage processor 202, memory 204, or communications hardware 206 as described above, it will be understood that the insight engine 208 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that insight engine 208 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of graphical user interfaces and flowcharts.

### Example Operations

FIGS. 3-10 illustrate example flowcharts that contain example operations implemented by example embodiments described herein. The operations illustrated in FIGS. 3-10 may, for example, be performed by system device of the insight analytics system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, insight engine 208, and/or any combination thereof. It will be understood that user interaction with the insight analytics system 102 may occur directly via communications hardware 206, or may instead be facilitated by a separate user device (e.g., one of user devices 106A-106N) and/or separate facility device (e.g., one of facility devices 108A-108N), as shown in FIG. 1, and which may have similar or equivalent physical componentry facilitating such user interaction.

Turning first to FIG. 3, example operations are shown for generating and providing an insight report for an entity. By way of the operations described in FIG. 3, time-sensitive emerging topics relating to an interest population may be identified for an entity and these topics and associated per-topic metric sets may be included in the insight report. As such, one or more entity personnel may review the insight report to obtain a comprehensive understanding of time-sensitive topics and may thus swiftly identify new potential issues that exist within the entity and take prompt corrective action to prevent further instance of these issues from occurring. Additionally, the insight engine of the insight analytics system is capable of processing a vast array of documents in an efficient manner to identify overall entity topics for an interest population in a time-sensitive manner, which would otherwise be an undue burden.

For example, multiple customers of a financial institution may be experiencing issues with logging in to their associated accounts due to a recently deployed system update that caused issues for certain customer accounts. These customers may reach out to the financial institution via phone calls, emails, virtual chats, and/or the like. Via the operations described below in FIG. 3, a topic relating to the login issues may be identified and included in the insight report. As such, entity personnel may take prompt corrective action to address the issue, such as deploying a patch to fix the issue and/or providing a notification to affected entity users alerting them that the issue has been identified and is being handled. Thus, this may increase overall entity user satisfaction with the entity and also increase interpretability and/or visibility of emerging topics described within documents of the entity. Additionally, by proactively identifying such topics, the insight analytics system ultimately reduces overall computational network usage and computational resource usage by proactively identifying emerging issues of an entity such that corrective actions may be taken in response to identification of these issues that may otherwise go unnoticed.

As shown by operation 302, the apparatus 200 includes means, such as processor 202, memory 204, communications hardware 206, insight engine 208, or the like, for receiving a configured input data set. In some embodiments, the communications hardware 206 may receive a configured input data set from a facility device (e.g., one of facility devices 108A-108N). The receipt of the configured input data set may prompt or otherwise cause the apparatus 200 to generate an insight report using the insight engine 208. In some embodiments, the configured input data set may describe a configuration for an insight engine and/or a type of insight report to generate.

The configuration parameter set may include one or more configuration parameters as configured by one or more entity personnel. In some embodiments, one or more of the configuration parameters may be configured in a default configuration parameter setting (e.g., set as default value) that entity personnel may change. The one or more configuration parameters may describe an insight engine run type, which may cause an insight engine to select a corresponding configuration that matches the insight engine run type. For example, in some embodiments, the insight engine run type may indicate a cross compare insight engine run type, a default insight engine run type, or a production insight engine run type. Each insight engine run type may be associated with a particular driver script, which may be determine various insight engine configuration parameters.

Additionally, the one or more configuration parameters may describe interest population criteria and, in some embodiments, reference population criteria. In some embodiments, interest population criteria may relate to a particular time frame. For example, interest population criteria may describe a rule that allows only documents which were received and/or generated within the last week to be included within an interest population. In some embodiments, the interest population criteria may relate to a particular type of entity user associated with a document. For example, the interest population criteria may describe a rule that allows only documents associated with entity users who are associated with an age group between 18 years old to 45 years old. Similarly, reference population criteria may relate to a particular time frame and/or particular type of entity user associated with documents. As such, an insight engine may be configured to determine an interest population and/or reference population based on the interest population criteria and reference population criteria, respectively and furthermore, may identify documents relating to each population. In some embodiments, the reference population includes the interest population within itself. For example, a reference population may include any entity user and all documents which were generated within the last month while an interest population may include any entity user and only documents which were generated within the last week.

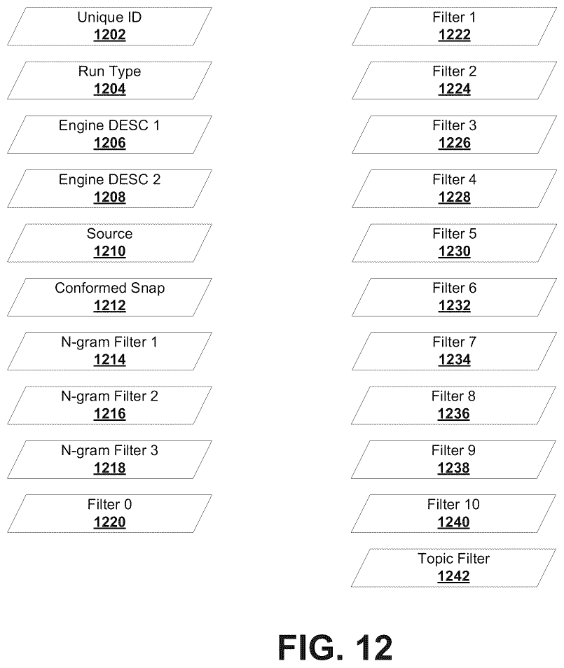

In some embodiments, the one or more configuration parameters may further describe one or more filters to apply to generated data (e.g., n-gram terms, n-gram pairs, etc.). The one or more filters may provide one or more rules which documents, n-gram terms, n-gram pairs, etc. must satisfy in order to be considered by the insight engine. In some embodiments, the one or more filters may enforce restrictions on the number of n-gram terms, n-gram pairs, and/or topics considered by the insight engine. As such, the filters described by the one or more configuration parameters may restrict a number of n-gram terms, n-gram pairs, topics, or the like, such that only the most relevant and/or significant n-gram terms, n-gram pairs, topics, etc. are selected for further processing, thereby resulting in a more computationally efficient process while still maintaining accuracy and robustness. Similarly, the filters described by the one or more configuration parameters may describe one or more conditional thresholds which a n-gram term, n-gram pairs, topics, etc. must satisfy in order to be processed further. For example, a filter may describe a particular n-gram ratio lift value which a n-gram lift value associated with a n-gram term must satisfy in order to be processed further. Examples of the one or more filters are described in more detail in FIG. 12.

The configured input data set may further include a source document set which includes one or more documents for processing. In some embodiments, the configured input data set may include a link or location of where documents included in the source document set are currently stored such that the documents themselves are not included in the configured input data set but may be accessed using the described location. The source document set may include one or more documents to be analyzed by the insight engine. The source document set may include a variety of document types including but not limited to phone transcripts, emails, virtual chats, surveys, etc. The documents included in the source document set may be pre-processed such that the characters included within the documents are transformed into machine-readable language. The documents may be pre-processed using any suitable techniques (e.g., optical character recognition (OCR), computer vision, etc.).

As shown by operation 304, the apparatus 200 includes means, such as processor 202, memory 204, communications hardware 206, insight engine 208, or the like, for selecting an insight engine configuration. As described above, the configured input data set may include a configured parameter set that includes one or more configuration parameters, including an insight engine run type configuration parameter. The insight engine 208 may process the configured input data set to determine which insight engine configuration to select. The insight engine 208 may then initialize an insight engine configuration that corresponds to the insight engine run type configuration parameter.

Each insight engine run type may be associated with a particular driver script, which may be determine various insight engine configuration parameters. The driver script for each insight engine run type may be stored and/or accessed from an associated memory (e.g., memory 204). A cross compare insight engine run type may be configured to compare an interest population to multiple reference populations, a default insight engine run type may be configured to compare an interest population to a single reference population, and a production insight engine run type may be configured to compare an interest population to a single reference population along with additional execution conditions (e.g., conditions set or programmed by an entity personnel, such as an administrator). The insight engine 208 may be configured to access and utilize the stored driver script for the selected insight engine configuration.

The insight engine 208 may also initialize one or more insight engine configuration parameters based on the configured input data set. For example, while certain insight engine configuration parameters of an insight engine run type may be set such that they may not be changed, other insight configuration parameters may be dynamic and may require initialization based on the configuration parameter set included in the configured input data set. As such, the insight engine 208 may be initialized to operate based on the one or more configuration parameters as supplied by an entity personnel associated with the configured input data set.

As shown by operation 306, the apparatus 200 includes means, such as processor 202, memory 204, communications hardware 206, insight engine 208, or the like, for generating an interest population document subset. In order to assess which n-gram terms are significant with respect to an interest population, the insight engine 208 must identify and determine which documents within the source document set correspond to the interest population and then may generate the interest population document subset to include these identified documents. The insight engine 208 may identify or otherwise determine which documents in the source document set to include in the interest population document subset based on the interest population criteria. For example, the interest population criteria may describe a set of rules which the one or more documents included in the source document set must satisfy in order to be included in the interest population document subset. In an instance a document satisfies the set of rules described by the interest population criteria, the insight engine 208 includes the document in the interest population document subset. Otherwise, the insight engine 208 does not include the document of the source document set in the interest population document subset.

In some embodiments, the set of rules described by the interest population criteria may control which documents are included based on an associated timestamp and/or date associated with the document. For example, interest population criteria may stipulate or describe a rule that only documents generated within the past week may be included in the interest population document subset. As such, only temporally recent documents may be included in the interest population document subset. For example, the source document set may include 1000 documents and the insight engine 208 may determine that only 100 documents have been generated within the past week. The insight engine 208 may then generate the interest population document subset to include only those 100 documents which have been determined to have been generated within the past week.

As another example, interest population criteria may stipulate or describe a rule that documents associated with only particular types of entity users may be included in the interest population document subset. As such, only documents that pertain to particular types of entity users may be included in the interest population document subset. In some embodiments, the insight engine 208 may access relevant entity user data (e.g., demographic data), such as data stored in associate entity user profiles in order to determine the type of entity user associated with the document. For example, the source document set may include 1000 documents and the insight engine 208 may determine that only 150 documents are associated with entity users associated with an age group between 18 years old to 45 years old. The insight engine 208 may then generate the interest population document subset to include only those 150 documents which have been determined to be associated with entity users of a particular entity user type.

As shown by operation 308, the apparatus 200 includes means, such as processor 202, memory 204, communications hardware 206, insight engine 208, or the like, for generating a reference population document subset. In addition to an interest population document subset, the insight engine 208 must also generate a reference population document subset, which may serve as a baseline comparison and therefore aid the insight engine 208 in to assessing which n-gram terms are significant with respect to an interest population. The insight engine 208 may identify and determine which documents within the source document set correspond to the reference population and then may generate the reference population document subset to include these identified documents. The insight engine 208 may identify or otherwise determine which documents in the source document set to include in the reference population document subset based on the reference population criteria. For example, the reference population criteria may describe a set of rules which the one or more documents included in the source document set must satisfy in order to be included in the reference population document subset. In an instance a document satisfies the set of rules described by the reference population criteria, the insight engine 208 includes the document in the reference population document subset. Otherwise, the insight engine 208 does not include the document of the source document set in the reference population document subset. One or more documents included in the reference population document subset may also be included in the interest population document subset. As such, the insight engine 208 may analyze each of the interest population document subset and reference population document subset separately and then compare the analysis results to determine a relative significance of n-gram terms. In some embodiments, the interest population criteria are more restrictive than the reference population criteria such that the interest population document subset may itself be a subset of the reference population document subset.

In some embodiments, the set of rules described by the reference population criteria may control which documents are included based on an associated timestamp and/or date associated with the document. For example, reference population criteria may stipulate or describe a rule that only documents generated within the past month may be included in the reference population document subset. As such, only temporally recent documents may be included in the reference population document subset. In some embodiments, the reference population criteria may therefore filter documents from the source document set but may include documents that fall within the interest population criteria as well. For example, the source document set may include 1000 documents and the insight engine 208 may determine that only 500 documents have been generated within the past month. The insight engine 208 may then generate the interest population document subset to include only those 500 documents which have been determined to have been generated within the past month.

As another example, reference population criteria may stipulate or describe a rule that documents associated with only particular types of entity users may be included in the reference population document subset. As such, only documents that pertain to particular types of entity users may be included in the reference population document subset. In some embodiments, the insight engine 208 may access relevant entity user data (e.g., demographic data), such as data stored in associate entity user profiles in order to determine the type of user associated with the document. For example, the source document set may include 1000 documents and the insight engine 208 may determine that only 600 documents are associated with entity users associated with an age group between 18 years old to 55 years old. The insight engine 208 may then generate the reference population document subset to include only those 600 documents which have been determined to be associated with users of a particular user type.

As shown by operation 310, the apparatus 200 includes means, such as processor 202, memory 204, communications hardware 206, insight engine 208, or the like, for generating a n-gram term set. Once the insight engine 208 is configured, the insight engine 208 may generate a n-gram term set for the configured input data set based on the source document set. In some embodiments, the insight engine 208 may generate the n-gram term set based on the interest population document subset. In particular, the insight engine 208 may process the one or more documents included in the interest population document subset to generate the n-gram term set. The n-gram term set may include one or more n-gram terms found within documents of the interest population document subset and thus, may be indicative of an emerging topic associated with the interest population.

A n-gram term may describe a continuous sequence of n items (e.g., words, symbols, tokens, etc.) found within documents of the interest population document subset. The number n items included in a n-gram term included in the n-gram term set may vary and may be based on a configuration parameter set and/or insight engine configuration. For example, a n-gram term may only include 1 item (e.g., a unigram), 2 items (e.g., a bigram), or 3 items (e.g., a trigram). The n-gram terms included in the n-gram term set may include n-gram terms with the same number of n items or a different number of n items. For example, the n-gram term set may include only bigram terms or may include unigram, bigram, and/or trigram terms.

To illustrate at a high level how n-gram terms within the n-gram term set may be generated, a document of the interest population document subset is considered. A sentence within the document may read as “I received a notification that I was double-charged.” Thus, the n-gram terms may include monograms such as “I”, “received”, “a”, “notification”, “that”, “I”, “was”, and/or “double-charged”, bigrams such as “I received”, “received a”, “a notification”, “notification that”, “that I”, “I was”, and/or “was double-charged”, or trigrams such as “I received a”, “received a notification”, “a notification that”, “notification that I”, “that I was”, and/or “I was double-charged”.

In some embodiments, a stop-word repository may be used to filter which n-gram terms are included within the n-gram term set. A stop-word repository may store a list of terms, words, symbols, tokens, etc. which describe terms for the insight engine 208 to ignore such that these terms are not included as a n-gram term. The stop-word repository may thus eliminate insignificant terms such as fillers, articles, or the like that may commonly occur but are not considered useful n-gram terms. By way of continuing example, the stop-word repository may include the terms “I”, “the”, “a”, “that”, and “was” such that the n-gram terms included in the n-gram term set may include only monograms such as “received”, “notification”, and/or “double-charged”, bigrams such as “received notification” and/or “notification double-charged”, or trigrams such as “received notification double-charged”. The stop-word repository may be stored and maintained in an associated memory, such as memory 204, such that the insight engine may access the stop-word repository when generating the n-gram terms for the n-gram term set.

As shown by operation 312, the apparatus 200 includes means, such as processor 202, memory 204, communications hardware 206, insight engine 208, or the like, for performing a streamline n-gram routine on the n-gram term set. In some embodiments, the insight engine 208 may perform additional operations on the n-gram terms included in the n-gram term set prior to generating an emerging topic set for an interest population. The streamline n-gram routine may include operations which assess the priority of each n-gram term, generate metrics for each n-gram term, filter n-gram terms, de-duplicate n-gram terms, and/or the like. The insight engine 208 may generate a n-gram term payload that includes filtered and de-duplicated n-gram terms, which may then be further processed by the insight engine. As such, the n-gram terms included in the n-gram term payload may be reduced further to remove duplication of similar n-gram terms (e.g., combine the n-gram terms double-charge and double charge) and further filter out less significant n-gram terms and/or prioritize the most significant n-gram terms. Thus, the streamline n-gram routine further improves computational efficiency of the insight engine by reducing the overall number of n-gram terms that need to be processed while still maintaining an accurate representation of the most significant n-gram terms for the configured input data set.

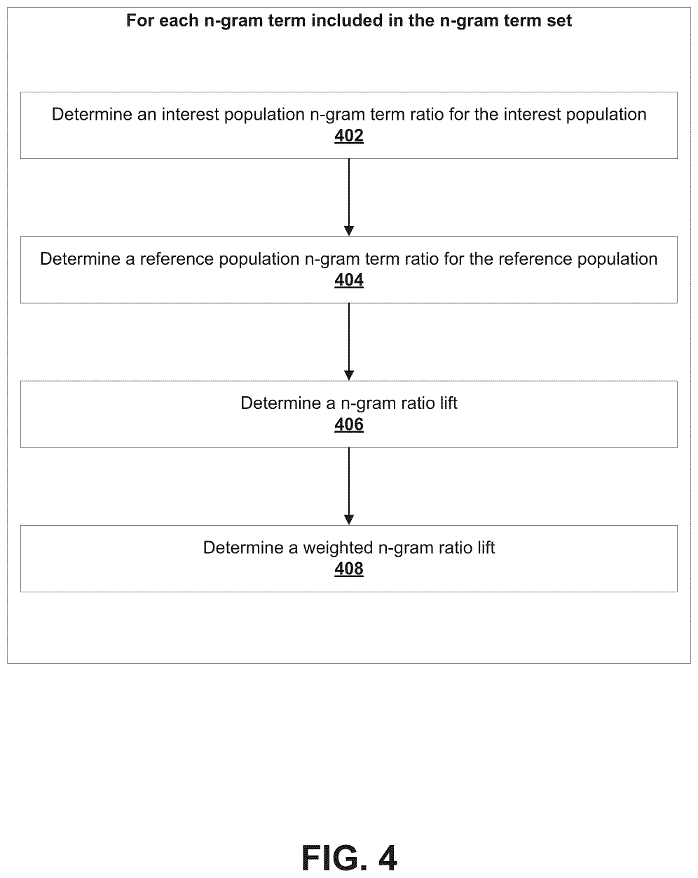

In some embodiments, operation 312 may be performed in accordance with the operations described by FIGS. 4-8B. Turning first to FIG. 4, operations are shown for determining a n-gram ratio lift and weighted n-gram ratio lift for each n-gram term in a n-gram term set. The n-gram ratio lift and weighted n-gram ratio lift for a n-gram term may serve as metrics for the n-gram term and may further, be used to rank or otherwise prioritize n-gram terms. Additionally, the n-gram ratio lift and/or weighted n-gram ratio lift for a n-gram term may be used to determine whether the n-gram term satisfies one or more condition thresholds described by the one or more configuration parameters of the configuration parameter set.

As shown by operation 402, the apparatus 200 includes means, such as processor 202, memory 204, communications hardware 206, insight engine 208, or the like, for determining an interest population n-gram term ratio for the interest population for each n-gram term in the n-gram term set. The insight engine 208 may be configured to determine an interest population n-gram term ratio for the interest population using the interest population document subset. The interest population n-gram term ratio may be indicative of a prevalence of the n-gram term within the documents of the interest population. In some embodiments, the interest population n-gram term ratio for the n-gram term may be stored and used as a metric for the corresponding n-gram term.

The insight engine 208 may determine the interest population n-gram term ratio for a given n-gram term based on an interest population document count and an interest population n-gram frequency count determined for that n-gram term. The interest population document count may be indicative of a number of documents included in the interest population document subset. The interest population n-gram frequency count may be indicative of a frequency count of a number of times the n-gram term appeared in the documents of the interest population document subset. Said otherwise, the interest population n-gram frequency count is indicative of the number of times the n-gram term appeared within the entirety of the interest population document subset. For example, an interest population document subset may include 100 documents. The insight engine 208 may thus determine an interest population document count of 100. The insight engine 208 may then determine an interest population n-gram frequency count for the n-gram term “double-charge”. The insight engine 208 may process the documents included in the interest population document subset to determine that the n-gram term “double-charge” occurred or appeared a total of 3 times within 40 of the documents of the interest population document subset and 2 times within 30 of the documents on the interest population document subset. As such, the insight engine 208 may determine the interest population n-gram frequency count to be 180.

In some embodiments, the insight engine 208 may determine the interest population n-gram term ratio by using the interest population n-gram frequency count as the dividend and the interest population document count as the divisor to yield a quotient that is the interest population n-gram term ratio (e.g., interest population n-gram frequency count divided by interest population document count to yield the interest population n-gram term ratio). By way of continuing example, the insight engine 208 may determine the reference population n-gram term ratio to be 1.8 based on the interest population n-gram frequency count of 180 and the interest population document count of 100.

As shown by operation 404, the apparatus 200 includes means, such as processor 202, memory 204, communications hardware 206, insight engine 208, or the like, for determining a reference population n-gram term ratio for the reference population for each n-gram term in the n-gram term set. The insight engine 208 may be configured to determine a reference population n-gram term ratio for the reference population using the reference population document subset. The reference population n-gram term ratio may be indicative of a prevalence of the n-gram term within the documents of the reference population. In some embodiments, the reference population n-gram term ratio for the n-gram term may be stored and used as a metric for the corresponding n-gram term.

The insight engine 208 may determine the reference population n-gram term ratio for a given n-gram term based on a reference population document count and a reference population n-gram frequency count determined for that n-gram term. The reference population document count may be indicative of a number of documents included in the reference population document subset. The reference population frequency count may be indicative of a frequency count of a number of times the n-gram term appeared in the documents of the reference population document subset. Said otherwise, the reference population frequency count is indicative of the number of times the n-gram term appeared within the entirety of the reference population document subset. For example, a reference population document subset may include 100 documents. The insight engine 208 may thus determine a reference population document count of 1000. The insight engine 208 may then determine a reference population n-gram frequency count for the n-gram term “double-charge”. The insight engine 208 may process the documents included in the reference population document subset to determine that the n-gram term “double-charge” occurred or appeared a total of 3 times within 50 of the documents of the reference population document subset and 2 times within 40 of the documents on the reference population document subset. As such, the insight engine 208 may determine the reference population frequency count to be 230.

In some embodiments, the insight engine 208 may determine the reference population n-gram term ratio by using the reference population n-gram frequency count as the dividend and the reference population document count as the divisor to yield a quotient that is the reference population n-gram term ratio (e.g., reference population n-gram frequency count divided by reference population document count to yield the reference population n-gram term ratio). By way of continuing example, the insight engine 208 may determine the reference population n-gram term ratio to be 0.23 based on the reference population frequency count of 230 and the reference population document count of 1000.

As shown by operation 406, the apparatus 200 includes means, such as processor 202, memory 204, communications hardware 206, insight engine 208, or the like, for determining a n-gram ratio lift for each n-gram term included in the n-gram term set. Once the insight engine 208 has determined an interest population n-gram term ratio and a reference population n-gram term ratio, the insight engine 208 may then determine a n-gram ratio lift for the n-gram term. The n-gram ratio lift for the n-gram term may be indicative of a relative rise in the usage or frequency of the n-gram term in the interest population with respect to the reference population and thus, may indicative whether the n-gram term has shifted in significance within the given interest population. For example, if the n-gram term “double charge” had increased significantly in usage within the past week as compared to the past month, this may indicate that the n-gram term “double-charge” is significant for the particular week. In some embodiments, the n-gram ratio lift for the n-gram term may be stored and used as a metric for the corresponding n-gram term. In some embodiments, the insight engine may use the n-gram ratio lift determined for each n-gram term to rank order the n-gram terms relative to one another.

In particular, the insight engine may determine the n-gram ratio lift for the n-gram term based on the associated interest population n-gram term ratio and the reference population n-gram term ratio. In particular, the insight engine 208 may determine the n-gram ratio lift for the n-gram term using equation 1 as follows:

$$n - gram ratio lift = \frac{( int pop n - gram term ratio - ref pop n - gram term ratio )}{ref pop n - gram term ratio} \qquad ( 1 )$$

where, “int” is used as an abbreviation for interest, “ref” is used as an abbreviation for reference, and “pop” Is used as an abbreviation for population in the above.

As shown by operation 408, the apparatus 200 includes means, such as processor 202, memory 204, communications hardware 206, insight engine 208, or the like, for determining a weighted n-gram ratio lift for each n-gram term in the n-gram term set. Once the insight engine 208 has determined the n-gram ratio lift for the n-gram, the insight engine 208 may then determine a n-gram weighted ratio lift for the n-gram term. The weighted n-gram ratio lift for the n-gram term may be indicative of a relative rise in the usage or frequency of the n-gram term in the interest population with respect to the reference population, similar to the n-gram ratio lift. However, the weighted n-gram ratio lift may additionally consider the frequency of occurrence of the n-gram term within the reference population document subset such that the ratio lift may further be weighted based on a volume of the n-gram term usage and frequency within the interest population. For example, if the n-gram term “double charge” had increased slightly in usage within the past week as compared to the past month, the n-gram ratio lift of the n-gram term “double-charge” may be relatively small compared to the n-gram ratio lift of other n-gram terms. However, if the n-gram term “double-charge” appears 1000 times within the interest population document subset whereas other n-gram terms appeared only 100 times within the interest population document subset, the weighted n-gram ratio lift may better reflect the frequency and significance of the “double-charge” n-gram term. In some embodiments, the weighted n-gram ratio lift for the n-gram term may be stored and used as a metric for the corresponding n-gram term. In some embodiments, the insight engine may use the weighted n-gram ratio lift determined for each n-gram term to rank order the n-gram terms relative to one another.

In particular, the insight engine may determine the weighted n-gram ratio lift for the n-gram term based on the associated n-gram ratio lift as determined in operation 406. In particular, the insight engine 208 may determine the weighted n-gram ratio lift for the n-gram term using equation 2 as follows:

$$weighted ng ratio lift = ng ratio lift * int pop ng frequency count \qquad ( 2 )$$

where, “int” is used as an abbreviation for interest, “ng” is used as an abbreviation for n-gram, and “pop” is used as an abbreviation for population in the above.

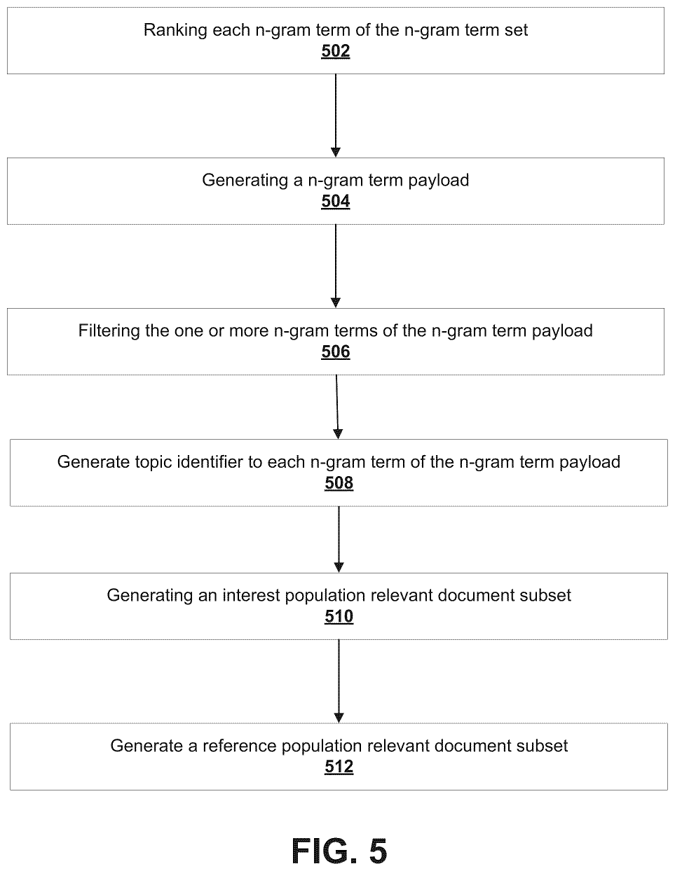

Turning now to FIG. 5, operations are shown for generating a n-gram term payload. As shown by operation 502, the apparatus 200 includes means, such as processor 202, memory 204, communications hardware 206, insight engine 208, or the like, for ranking each n-gram term of the n-gram term set. Once the insight engine 208 has determined a n-gram ratio lift and/or weighted n-gram ratio lift for each n-gram term in the n-gram term set, the insight engine 208 may rank the n-gram terms within the n-gram term set based on their associated n-gram ratio lift and/or weighted n-gram ratio lift. In some embodiments, the particular insight engine configuration of the insight engine 208 may determine how the n-gram ratio lift and/or weighted n-gram ratio lift are used to rank and/or order the n-gram terms within the n-gram set. For example, an insight engine configuration A may include instructions for ranking the n-gram terms based on only the n-gram ratio lift, an insight engine configuration B may include instructions for ranking the n-gram terms based on only the weighted n-gram ratio lift, and an insight engine configuration C may include instructions for ranking the n-gram terms based on the n-gram ratio lift and the weighted n-gram ratio lift (e.g., may combine the n-gram ratio lift and the weighted n-gram ratio lift of the n-gram terms to generate a combined n-gram ratio lift using weights for each of the n-gram ratio lift and the weighted n-gram ratio lift). In some embodiments, the insight engine 208 may order the n-gram terms within the n-gram term set based on their associated ranking. In some embodiments, the insight engine 208 may assign each n-gram term a rank order position, which may be indicative of an associated ranking position for the n-gram term.

As shown by operation 504, the apparatus 200 includes means, such as processor 202, memory 204, communications hardware 206, insight engine 208, or the like, for generating a n-gram term payload. Once the insight engine 208 has ranked each n-gram term, the insight engine may generate a n-gram term payload. The n-gram term payload may include the n-gram terms which may be ordered based on their associated ranking, as determined in operation 502. For example, the n-gram term payload may position the n-gram term associated with the highest n-gram ratio lift and/or weighted n-gram ratio lift in a first position in an ordered list followed by the n-gram term with the second highest n-gram ratio lift and/or weighted n-gram ratio lift and continue this ordering until all n-gram terms are placed in an associated position. The n-gram term payload may undergo further processing to refine the n-gram terms included in the n-gram term payload.

As shown by operation 506, the apparatus 200 includes means, such as processor 202, memory 204, communications hardware 206, insight engine 208, or the like, for filtering the one or more n-gram terms of the n-gram term payload. As described above, the one or more configuration parameters initialized by the insight engine 208 may include one or more filters. In some embodiments, the one or more filters may provide one or more rules which n-gram terms must satisfy in order to be considered by the insight engine. In some embodiments, the one or more filters may enforce restrictions on the number of n-gram terms and/or one or more conditional thresholds which a n-gram term must satisfy to be further considered by the insight engine. Thus, filtering the n-gram term payload may refine and limit the number of n-gram terms considered such that the n-gram term payload includes only the most significant n-gram terms, which thereby reduces future computational processing burdens and conserves computational resources.

In some embodiments, the insight engine 208 may use the one or more filters described by the one or more configuration parameters to filter n-gram terms within the n-gram term payload. In some embodiments, a configuration parameter may require the n-gram term payload to only include a set number of n-gram terms. For example, a filter described by a configuration parameter may set a limit of 1000 n-gram terms for the n-gram term payload. As such, the insight engine 208 may only keep the first 1000 n-gram terms of the n-gram term payload and remove the remaining n-gram terms from the n-gram term payload. Additionally, since the n-gram terms included in the n-gram term payload are ordered based on an associated n-gram ratio lift and/or weighted n-gram ratio lift, the most significant 1000 n-gram terms of the n-gram term payload may remain while the less significant n-gram terms are removed.

In some embodiments, one or more filters described by one or more configuration parameters may describe a condition that each n-gram term needs to satisfy to be included in the n-gram term payload. The conditions described by the one or more filters may relate to metric thresholds, such as an associated interest population n-gram frequency count threshold, reference population n-gram frequency count threshold, interest population n-gram term ratio threshold, reference population n-gram term ratio threshold, n-gram term ratio threshold, and/or weighted n-gram term ratio threshold which a corresponding value of a n-gram term must satisfy in order to be included in the n-gram term payload. As such, the insight engine 208 may only keep n-gram terms which satisfy quality metrics imposed by the one or more filters. For example, a filter described by a configuration parameter may describe a n-gram term ratio threshold of 1. As such, the insight engine 208 may determine whether the n-gram terms included in the n-gram term payload are associated with a n-gram term ratio of 1 or greater. In an instance the insight engine 208 determines the n-gram term ratio associated with a n-gram term satisfies the n-gram term ratio threshold, the insight engine 208 may keep the n-gram term in the n-gram term payload. In an instance the insight engine 208 determines the n-gram term ratio associated with a n-gram term fails to satisfy the n-gram term ratio threshold, the insight engine 208 may remove the n-gram term in the n-gram term payload. Thus, only n-gram terms which are associated with metrics (e.g., interest population n-gram frequency count, reference population n-gram frequency count, interest population n-gram term ratio, reference population n-gram term ratio, n-gram term ratio, and/or weighted n-gram term ratio) which satisfy metric thresholds may be included in the n-gram term payload such that the n-gram terms included in the n-gram term payload are quality controlled.

In some embodiments, the one or more filters may relate to metric thresholds which may require the insight engine 208 to perform additional calculations and/or logical operations to determine whether a n-gram term satisfies a metric threshold. For example, a filter may require the n-gram term to occur within document frequency threshold. A document frequency threshold may be determined based on the number of documents in a subset (e.g., an interest population document subset or reference population document subset) which include the n-gram term at least once. For example, the document frequency threshold for the interest population may be 0.4 such that at least 0.4 percent of the documents included in the interest document subset must include the n-gram term at least once in order for the n-gram term to be included in the n-gram term payload. As another example, the document frequency threshold for the reference population may be 100000 such that no more than 10000 documents included in the reference document subset may include the n-gram term.

As shown by operation 508, the apparatus 200 includes means, such as processor 202, memory 204, communications hardware 206, insight engine 208, or the like, for generating a topic identifier to each n-gram term of the n-gram term payload. Once the n-gram terms of the n-gram term payload have been filtered, the insight engine 208 may generate a topic identifier for each n-gram term of the n-gram term payload and assign a topic identifier to each n-gram term. The topic identifier may uniquely identify the n-gram term from other n-gram terms. The topic identifier may also be associated with the one or more metrics determined for the n-gram term, such as the interest population n-gram frequency count, the reference population n-gram frequency count, interest population n-gram term ratio, reference population n-gram term ratio, n-gram ratio lift, weighted n-gram ratio lift, and/or the like.

As shown by operation 510, the apparatus 200 includes means, such as processor 202, memory 204, communications hardware 206, insight engine 208, or the like, for generating an interest population relevant document subset. Once the insight engine 208 generates and filters the n-gram term payload, the insight engine 208 may generate an interest population relevant document subset for the interest population. The interest population relevant document subset may refine the interest population document set to include only the documents which include one or more of the n-gram terms included in the n-gram term payload and may exclude documents of the interest population document subset which do not include n-gram terms included in the n-gram term payload. In an instance a document include in the interest population document subset includes at least one n-gram term which corresponds to a n-gram term included in the n-gram term payload, the insight engine 208 may include or append the document to the interest population relevant document subset. Otherwise, the insight engine 208 does not include the document of the interest population document subset in the interest population relevant document subset. As such, the interest population relevant document subset may refine the documents pertaining to the interest population to only those documents which include the n-gram terms of interest (e.g., n-gram terms which are included in the n-gram term payload), which allows the insight engine 208 to reduce the number of documents which need processing to only the documents relevant to the n-gram term payload.

As shown by operation 512, the apparatus 200 includes means, such as processor 202, memory 204, communications hardware 206, insight engine 208, or the like, for generating a reference population relevant document subset. Similar to operation 508, once the insight engine 208 generates and filters the n-gram term payload, the insight engine 208 may generate a reference population relevant document subset for the reference population. The reference population relevant document subset may refine the reference population document set to include only the documents which include one or more of the n-gram terms included in the n-gram term payload and may exclude documents of the reference population document subset which do not include n-gram terms included in the n-gram term payload. In an instance a document include in the reference population document subset includes at least one n-gram term which corresponds to a n-gram term included in the n-gram term payload, the insight engine 208 may include or append the document to the reference population relevant document subset. Otherwise, the insight engine 208 does not include the document of the reference population document subset in the reference population relevant document subset. As such, the reference population relevant document subset may refine the documents pertaining to the reference population to only those documents which include the n-gram terms of reference (e.g., n-gram terms which are included in the n-gram term payload), which allows the insight engine 208 to reduce the number of documents which need processing to only the documents relevant to the n-gram term payload

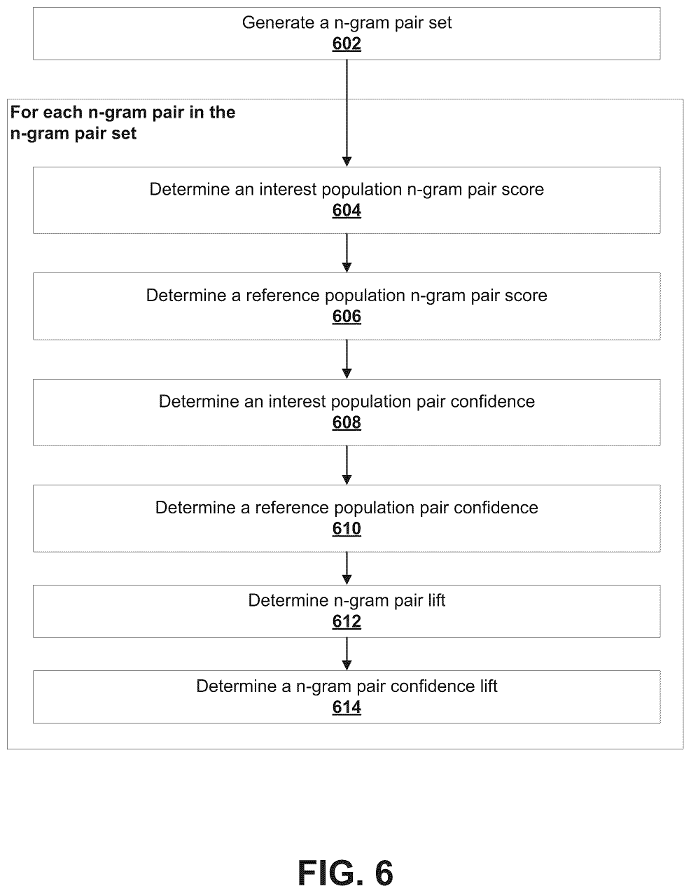

Turning now to FIG. 6, operations are shown for determining a n-gram pair lift and n-gram pair confidence lift for each n-gram pair. In particular, FIG. 6 describes operations for generating n-gram pairs, which may be useful to determine whether the n-gram terms included in the n-gram pair are highly correlated. In an instance where n-gram terms are highly correlated, a single topic may be generated to associated with n-gram terms with one another. Thus, the insight engine 208 may reduce the number of topics which need to be processed by associated highly correlated n-gram terms with the same topic.

As shown by operation 602, the apparatus 200 includes means, such as processor 202, memory 204, communications hardware 206, insight engine 208, or the like, for generating a n-gram pair set. A n-gram pair set may include one or more n-gram pairs, which may be generated based on the n-gram term payload. A n-gram pair may be an ordered pair of n-gram terms which includes a first n-gram term and a second n-gram term. The n-gram term selected for the first n-gram term and second n-gram term of the n-gram pair may be selected from the n-gram term payload. The first n-gram term and second n-gram term may be different n-gram terms of the n-gram term payload. The insight engine 208 may generate the n-gram pair set to include each permutation or combination of n-gram terms such that a n-gram term correlation may be inferred for each n-gram term with respect to other n-gram terms included in the n-gram term payload.

To illustrate a simple example of a n-gram pair set, consider a n-gram term payload that includes only 3 n-gram terms, n-gram term 1, n-gram term 2, and n-gram term 3. The insight engine 208 may then generate a n-gram pair set that includes 6 n-gram pairs of the form (n-gram term 1, n-gram term 2), (n-gram term 1, n-gram term 3), (n-gram term 2, n-gram term 1), (n-gram term 2, n-gram term 3), (n-gram term 3, n-gram term 1), and (n-gram term 3, n-gram term 2).

As shown by operation 604, the apparatus 200 includes means, such as processor 202, memory 204, communications hardware 206, insight engine 208, or the like, for generating an interest population n-gram pair score for each n-gram pair in the n-gram pair set. Once the insight engine 208 has generated the n-gram pair set, the insight engine 208 may further determine an interest population n-gram pair score for each n-gram pair. The interest population n-gram pair score for the n-gram pair may be indicative of the co-occurrence of the n-gram terms of the n-gram pair together within the interest population. In particular, the insight engine 208 may determine an overall interest population n-gram term 1 count indicative of the number of documents within the interest population document subset that include the n-gram term 1, an overall interest population n-gram term 2 count indicative of the number of documents within the interest population document subset that include the n-gram term 2, and an overall interest population n-gram both count indicative of the number of documents within the interest population document subset that include both the n-gram term 1 and the n-gram term 2. Then, the insight engine 208 may determine the interest population n-gram pair score using equation 3 as follows:

$$int pop ng pair score = \frac{( ov int pop ng both ct * ov int pop ng both ct )}{( ov int pop ng term 1 ct * ov int pop ng term 2 ct )} \qquad ( 3 )$$

where, “int” is used as an abbreviation for interest, “ng” is used as an abbreviation for n-gram, “ov” is used as an abbreviation for overall, “ct” is used as an abbreviation for count, and “pop” is used as an abbreviation for population in the above.

As shown by operation 606, the apparatus 200 includes means, such as processor 202, memory 204, communications hardware 206, insight engine 208, or the like, for generating a reference population n-gram pair score for each n-gram pair in the n-gram pair set. Similar to operation 604, once the insight engine 208 has generated the n-gram pair set, the insight engine 208 may further determine a reference population n-gram pair score for each n-gram pair. The reference population n-gram pair score for the n-gram pair may be indicative of the co-occurrence of the n-gram terms of the n-gram pair together within the reference population.

In particular, the insight engine 208 may determine an overall reference population n-gram term 1 count indicative of the number of documents within the reference population document subset that include the n-gram term 1, an overall reference population n-gram term 2 count indicative of the number of documents within the reference population document subset that include the n-gram term 2, and an overall reference population n-gram both count indicative of the number of documents within the reference population document subset that include both the n-gram term 1 and the n-gram term 2. Then, the insight engine 208 may determine the reference population n-gram pair score using equation 4 as follows:

$$ref pop ng pair score = \frac{( ov ref pop ng both ct * ov ref pop ng both ct )}{( ov ref pop ng term 1 ct * ov ref pop ng term 2 ct )} \qquad ( 4 )$$

where, “ref” is used as an abbreviation for reference, “ng” is used as an abbreviation for n-gram, “ov” is used as an abbreviation for overall, “ct” is used as an abbreviation for count, and “pop” is used as an abbreviation for population in the above.

As shown by operation 608, the apparatus 200 includes means, such as processor 202, memory 204, communications hardware 206, insight engine 208, or the like, for generating an interest population pair confidence for each n-gram pair in the n-gram pair set. Once the insight engine 208 determines the interest population n-gram pair score for the n-gram pair, the insight engine 208 may further determine an interest population pair confidence for the n-gram pair. The interest population pair confidence for a n-gram pair may be indicative of an overall reliability associated with the interest population n-gram pair score. Said otherwise, the interest population pair confidence score for a n-gram pair may be indicative of an overall reliability of an inferred correlation between the n-gram terms included in the n-gram pair. In some embodiments, the interest population pair confidence may be indicative of an overall reliability that the n-gram term 1 of the n-gram pair is correlated with n-gram term 2.

In particular, the insight engine 208 may use the overall interest population n-gram term 1 count and overall interest population n-gram both count for the n-gram pair. The insight engine 208 may determine the interest population pair confidence using equation 5 as follows:

$$int pop pair confidence = \frac{( overall int pop n - gram both count )}{( overall int pop n - gram term 1 count )} \qquad ( 5 )$$

where, “int” is used as an abbreviation for interest and “pop” is used as an abbreviation for population in the above.

As shown by operation 610, the apparatus 200 includes means, such as processor 202, memory 204, communications hardware 206, insight engine 208, or the like, for generating a reference population pair confidence for each n-gram pair in the n-gram pair set. Similar to operation 608, once the insight engine 208 determines the reference population n-gram pair score for the n-gram pair, the insight engine 208 may further determine a reference population pair confidence for the n-gram pair. The reference population pair confidence for a n-gram pair may be indicative of an overall reliability associated with the reference population n-gram pair score. Said otherwise, the reference population pair confidence score for a n-gram pair may be indicative of an overall reliability of an inferred correlation between the n-gram terms included in the n-gram pair. In some embodiments, the reference population pair confidence may be indicative of an overall reliability that the n-gram term 1 of the n-gram pair is correlated with n-gram term 2.

In particular, the insight engine 208 may use the overall reference population n-gram term 1 count and overall reference population n-gram both count for the n-gram pair. The insight engine 208 may determine the reference population pair confidence using equation 6 as follows:

$$ref pop pair confidence = \frac{( overall ref pop n - gram both count )}{( overall ref pop n - gram term 1 count )} \qquad ( 6 )$$

where, “ref” is used as an abbreviation for reference and “pop” is used as an abbreviation for population in the above.

As shown by operation 612, the apparatus 200 includes means, such as processor 202, memory 204, communications hardware 206, insight engine 208, or the like, for determining a n-gram pair lift for each n-gram pair in the n-gram pair set. The n-gram pair lift for the n-gram pair may be indicative of a relative rise in the usage or frequency of both n-gram terms included in the n-gram pair in the interest population with respect to the reference population. For example, if the n-gram term “double charge” and n-gram term “notification” have increased significantly in usage within the past week as compared to the past month, this may indicate that the n-gram terms “double-charge” and “notification” are significant for the particular week. Additionally, the n-gram pair lift for a n-gram pair may also assist with accounting for certain errors or differences within the data of the documents. For example, some documents may be transcripts of phone calls which were produced using various voice-to-text techniques and/or certain users may use different spellings of terms within their email correspondence. As a particular example, the term “double charge” and “double-charge” are alternate spellings of the same topic. In some embodiments, the n-gram pair lift for both n-gram terms of the n-gram pair may be stored and used as a metric for the n-gram terms.

In particular, the insight engine may determine the n-gram pair lift for the n-gram pair based on the associated interest population n-gram pair score and reference population n-gram pair score for the n-gram pair as determined in operation 604 and 606. In particular, the insight engine 208 may determine the n-gram pair lift for the n-gram pair using equation 7 as follows:

$$n - gram pair lift = \frac{( int pop n - gram pair score - ref pop n - gram pair score )}{ref pop n - gram pair score} \qquad ( 7 )$$

where, “int” is used as an abbreviation for interest, “ref” is used as an abbreviation for reference, and “pop” is used as an abbreviation for population in the above.

As shown by operation 614, the apparatus 200 includes means, such as processor 202, memory 204, communications hardware 206, insight engine 208, or the like, for determining a n-gram pair confidence lift for each n-gram pair in the n-gram pair set. The n-gram pair confidence lift for the n-gram pair may be indicative an overall reliability associated with the n-gram pair lift. In particular, the insight engine may determine the n-gram pair confidence lift for the n-gram pair based on the associated interest population n-gram pair confidence lift and reference population n-gram pair confidence lift for the n-gram pair as determined in operation 608 and 610. In particular, the insight engine 208 may determine the n-gram pair confidence lift for the n-gram pair using equation 8 as follows:

$$np confidence lift = \frac{( int pop np confidence lift - ref pop np confidence lift )}{ref pop n - gram pair confidence lift} \qquad ( 8 )$$

where, “int” is used as an abbreviation for interest, “ref” is used as an abbreviation for reference, “np” is used as an abbreviation for n-gram pair, and “pop” is used as an abbreviation for population in the above.

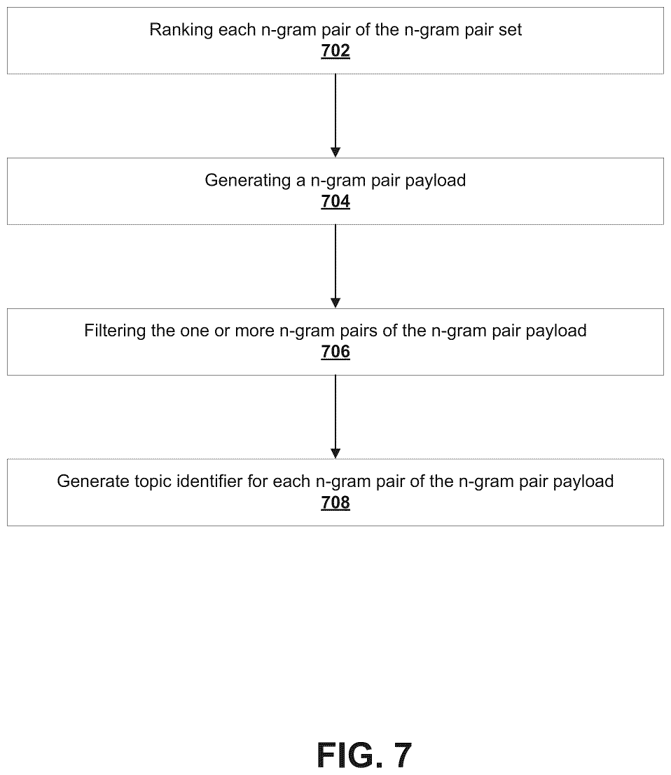

Turning now to FIG. 7, operations are shown for generating a n-gram term payload. As shown by operation 702, the apparatus 200 includes means, such as processor 202, memory 204, communications hardware 206, insight engine 208, or the like, for ranking each n-gram pair of the n-gram pair set. Once the insight engine 208 has determined a n-gram pair lift and/or n-gram pair confidence lift for each n-gram pair in the n-gram pair set, the insight engine 208 may rank the n-gram pairs within the n-gram pair set based on their associated interest population n-gram pair score, n-gram pair lift and n-gram pair confidence lift. In some embodiments, the particular insight engine configuration of the insight engine 208 may determine a n-gram pair ranking score for each n-gram pair using equation 9 as follows:

$$np ranking score = int pop np score * ( np lift + np confidence lift ) \qquad ( 9 )$$

“int” is used as an abbreviation for interest, “pop” is used as an abbreviation for population, and “np” is used as an abbreviation for n-gram pair in the above.

Once the insight engine 208 has determined a n-gram pair ranking score for each n-gram pair, the insight engine 208 may rank each n-gram pair based on the associated n-gram pair ranking score for the n-gram pair. In some embodiments, the insight engine 208 may order the n-gram pairs within the n-gram pair set based on their associated n-gram pair ranking score. In some embodiments, the insight engine 208 may assign each n-gram pair a rank order position, which may be indicative of an associated ranking position for the n-gram pair.

As shown by operation 704, the apparatus 200 includes means, such as processor 202, memory 204, communications hardware 206, insight engine 208, or the like, for generating a n-gram pair payload. Once the insight engine 208 has ranked each n-gram pair, the insight engine may generate a n-gram pair payload. The n-gram pair payload may include the n-gram pairs which may be ordered based on their associated ranking, as determined in operation 702. For example, the n-gram pair payload may position the n-gram pair associated with the highest n-gram pair ranking score in a first position in an ordered list followed by the n-gram pair with the second highest n-gram pair ranking score and continue this ordering until all n-gram pairs are placed in an associated position. The n-gram pair payload may undergo further processing to refine the n-gram pairs included in the n-gram pair payload.

As shown by operation 706, the apparatus 200 includes means, such as processor 202, memory 204, communications hardware 206, insight engine 208, or the like, for filtering the one or more n-gram pairs of the n-gram pair payload. As described above, the one or more configuration parameters initialized by the insight engine 208 may include one or more filters. In some embodiments, the one or more filters may provide one or more rules which n-gram pairs must satisfy in order to be considered by the insight engine 208. In some embodiments, the one or more filters may enforce restrictions on the number of n-gram pairs and/or one or more conditional thresholds which a n-gram pair must satisfy to be further considered by the insight engine. Thus, filtering the n-gram pair payload may refine and limit the number of n-gram pairs considered such that the n-gram pair payload includes only n-gram pairs inferred to have a higher relative probability of being correlated while eliminating n-gram pairs which are unlikely to be correlated, thereby reducing future computational processing burden and conserving computational resources.

In some embodiments, the insight engine 208 may use the one or more filters described by the one or more configuration parameters to filter n-gram pairs within the n-gram pair payload. In some embodiments, a configuration parameter may require the n-gram pair payload to only include a set number of n-gram pairs. For example, a filter described by a configuration parameter may set a limit of 100 n-gram pairs for the n-gram pair payload. As such, the insight engine 208 may only keep the first 100 n-gram pairs of the n-gram pair payload and remove the remaining n-gram pairs from the n-gram pair payload. Additionally, since the n-gram pairs included in the n-gram pair payload are ordered based on an associated n-gram pair ranking score, the most correlated 100 n-gram pairs of the n-gram pair payload may remain while the less correlated n-gram pairs are removed.

In some embodiments, one or more filters described by one or more configuration parameters may describe a condition that each n-gram pair needs to satisfy to be included in the n-gram pair payload. The conditions described by the one or more filters may relate to metric thresholds, such as an associated interest population n-gram pair score threshold, reference population n-gram pair score threshold, interest population pair confidence threshold, reference population pair confidence threshold, n-gram pair lift threshold, and/or n-gram pair confidence lift threshold which a corresponding value of a n-gram pair must satisfy in order to be included in the n-gram pair payload. As such, the insight engine 208 may only keep n-gram pairs which satisfy quality metrics imposed by the one or more filters. For example, a filter described by a configuration parameter may describe an interest population n-gram pair score threshold of 1. As such, the insight engine 208 may determine whether the n-gram pairs included in the n-gram pair payload are associated with an interest population n-gram pair score of 1 or greater. In an instance the insight engine 208 determines the interest population n-gram pair score associated with a n-gram pair satisfies the interest population n-gram pair score threshold, the insight engine 208 may keep the n-gram pair in the n-gram pair payload. In an instance the insight engine 208 determines the interest population n-gram pair score associated with a n-gram pair fails to satisfy the interest population n-gram pair score threshold, the insight engine 208 may remove the n-gram pair in the n-gram pair payload. Thus, only n-gram pairs which are associated with metrics (e.g., interest population n-gram pair score, reference population n-gram pair score, interest population pair confidence, reference population pair confidence, n-gram pair lift threshold, and/or n-gram pair confidence lift) which satisfy metric thresholds may be included in the n-gram pair payload such that the n-gram pairs included in the n-gram pair payload are quality controlled.

In some embodiments, the one or more filters may relate to metric thresholds which may require the insight engine 208 to perform additional calculations and/or logical operations to determine whether a n-gram pair satisfies a metric threshold. For example, a filter may require the n-gram pair to occur within document frequency threshold. A document frequency threshold may be determined based on the number of documents in a subset (e.g., an interest population document subset or reference population document subset) which includes both n-gram terms of the n-gram pair at least once. For example, the document frequency threshold for the interest population may be 0.4 such that at least 0.4 percent of the documents included in the interest document subset must include the both the first n-gram term and second n-gram term of the n-gram pair at least once in order for the n-gram pair to be included in the n-gram pair payload. As another example, the document frequency threshold for the reference population may be 100000 such that no more than 10000 documents included in the reference document subset may include the first n-gram term and the second n-gram term of the n-gram pair.

As shown by operation 708, the apparatus 200 includes means, such as processor 202, memory 204, communications hardware 206, insight engine 208, or the like, for generating a topic identifier to each n-gram pair of the n-gram payload. Once the insight engine 208 has filtered the n-gram pairs of the n-gram pair payload, the n-gram pairs remaining in the n-gram pair payload are inferred to be highly correlated. The insight engine may then generate a topic identifier for each n-gram pair of the n-gram pair payload and assign a topic identifier to each n-gram pair in the n-gram pair payload. As such, the n-gram terms of the n-gram pair should be assigned a same topic identifier such that these n-gram terms may be considered together for further processing operations. Thus, a single topic identifier may be generated for the n-gram terms of the n-gram pair. The topic identifier may also be associated with the one or more metrics determined for the n-gram pair, such as the interest population n-gram pair score, reference population n-gram pair score, interest population pair confidence, reference population pair confidence, n-gram pair lift, n-gram pair confidence lift, and/or the like.

In some embodiments, the n-gram terms of the n-gram pair may have each been previously assigned a topic identifier. Since the n-gram terms have now been determined to be highly correlated by the insight engine 208, both n-gram terms may be assigned a single topic identifier and the insight engine may delete the previous topic identifiers associated with the respective n-gram terms. The topic identifier for the n-gram pair may still include one or more metrics determined for each n-gram term of the n-gram pair, such as the interest population n-gram frequency count, the reference population n-gram frequency count, interest population n-gram term ratio, reference population n-gram term ratio, n-gram ratio lift, weighted n-gram ratio lift, and/or the like for both n-gram terms of the n-gram pair.

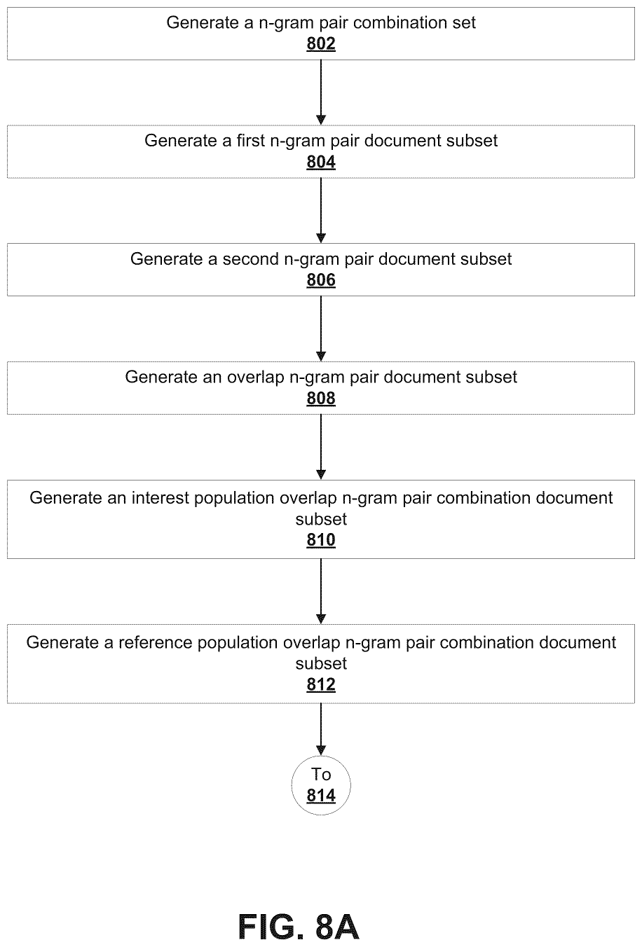

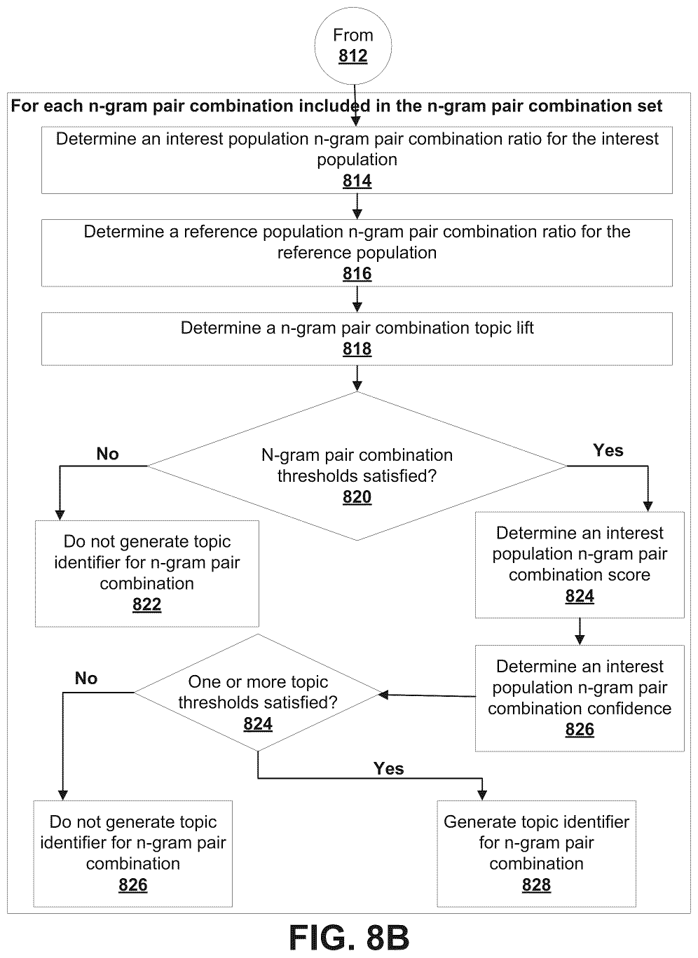

Turning now to FIGS. 8A-8B, operations are shown for generating topics associated with one or more n-gram terms. In some embodiments, the insight engine 208 may perform one or more additional operations on the n-gram pair payload to determine whether n-gram pairs are highly correlated with one another. If the insight engine 208 determines n-gram pairs to be highly correlated, the insight engine may assign these highly correlated n-gram pair the same topic identifier such that these n-gram terms of the n-gram pairs may be considered together.

As shown by operation 802 in FIG. 8A, the apparatus 200 includes means, such as processor 202, memory 204, communications hardware 206, insight engine 208, or the like, for generating a n-gram pair combination set. A n-gram pair combination set may include one or more n-gram pair combinations, which may be generated based on the n-gram pair payload. A n-gram pair combination may include two or more n-gram pairs. For example, a first n-gram pair may include a first n-gram term of “double-charge” and a second n-gram term of “notification”, while a second n-gram pair may include a first n-gram term of “alert” and a second n-gram term of “company ABC”. As such, the insight engine 208 may generate a n-gram pair combination that includes the first n-gram pair and second n-gram pair of the form ((“double-charge”, “notification”), (“alert”, “company ABC”)). In some embodiments, the insight engine 208 may generate the n-gram pair combination set to include each permutation or combination of n-gram pairs such that a n-gram pair correlation may be inferred for between all n-gram pairs with respect to other n-gram pairs included in the n-gram pair payload.

In some embodiments, the n-gram pairs of the n-gram payload may include a same n-gram term. For example, a first n-gram pair may include a first n-gram term of “double-charge” and a second n-gram term of “notification”, while a second n-gram pair may include a first n-gram term of “double-charge” and a second n-gram term of “company ABC”. In some embodiments, the insight engine 208 may only generate n-gram pair combinations for n-gram pairs which share a n-gram term. As such, this may reduce the overall number of processing operations required to be performed by the insight engine 208.

As shown by operation 804, the apparatus 200 includes means, such as processor 202, memory 204, communications hardware 206, insight engine 208, or the like, for generating a first n-gram pair document subset for each n-gram pair included in the n-gram pair payload. The insight engine 208 may generate a first n-gram pair document subset for the first n-gram pair of the n-gram pair combination. The first n-gram pair document subset may use the interest population relevant document subset and/or reference population relevant document subset to identify documents which include the n-gram terms included in the first n-gram pair and in an instance a document includes the first n-gram term and second n-gram term of the n-gram pair, the insight engine 208 may include or append the document in the first n-gram pair document subset. Otherwise, the insight engine 208 does not include the document in the first n-gram pair document subset. As such, the first n-gram pair document subset may refine the relevant documents (e.g., of the interest population relevant document subset and/or reference population relevant document subset) to only those documents which include the n-gram terms of the first n-gram pair.

As shown by operation 806, the apparatus 200 includes means, such as processor 202, memory 204, communications hardware 206, insight engine 208, or the like, for generating a second n-gram pair document subset for each n-gram pair included in the n-gram pair payload. The insight engine 208 may generate a second n-gram pair document subset for the second n-gram pair of the n-gram pair combination. The second n-gram pair document subset may use the interest population relevant document subset and/or reference population relevant document subset to identify documents which include the n-gram terms included in the second n-gram pair and in an instance a document includes the second n-gram term and second n-gram term of the n-gram pair, the insight engine 208 may include or append the document in the second n-gram pair document subset. Otherwise, the insight engine 208 does not include the document in the second n-gram pair document subset. As such, the second n-gram pair document subset may refine the relevant documents (e.g., of the interest population relevant document subset and/or reference population relevant document subset) to only those documents which include the n-gram terms of the second n-gram pair

As shown by operation 808, the apparatus 200 includes means, such as processor 202, memory 204, communications hardware 206, insight engine 208, or the like, for generating an overlap n-gram pair document subset for each n-gram pair combination included in the n-gram pair combination set. Once the insight engine 208 has generated the first n-gram pair document subset and second n-gram pair document subset, the insight engine 208 may generate the overlap n-gram pair document subset. The overlap n-gram pair document subset may include only documents which are found in both the first n-gram pair document subset and second n-gram pair document subset. The insight engine 208 may perform comparisons on documents included in the first n-gram pair document subset and/or second n-gram pair document subset to determine if a document included in the subset also is included in the other subset. In an instance the document of a document subset (e.g., first n-gram pair document subset or second n-gram pair document subset) is also included in the other document subset (e.g., second n-gram pair document subset or first n-gram pair document subset), the insight engine 208 may include the document in the overlap n-gram pair document subset. Otherwise, the insight engine 208 may not include the document in the overlap n-gram pair document subset.

In some embodiments, the insight engine 208 may determine a document count for each of the first n-gram pair document subset and second n-gram pair document subset and may use the subset which includes the fewest documents, since this subset will be the more restrictive subset. For example, the insight engine 208 may determine that the first n-gram pair document subset includes 100 documents while the second n-gram pair document subset includes 200 documents. Thus, the insight engine 208 may select from documents included in the first n-gram pair document subset and determine if a respective document is also included in the second n-gram term document subset. In an instance the document of the first n-gram pair document subset is also included in the second n-gram pair document subset, the insight engine 208 may include the document in the overlap n-gram pair document subset.

As shown by operation 810, the apparatus 200 includes means, such as processor 202, memory 204, communications hardware 206, insight engine 208, or the like, for generating an interest population overlap n-gram pair combination document subset. The insight engine 208 may identify and determine which documents within the overlap document n-gram pair document subset correspond to the interest population and then may generate the interest population overlap n-gram pair combination document subset to include these identified documents. The insight engine 208 may identify or otherwise determine which documents in the overlap n-gram pair document subset to include in the interest population overlap n-gram pair combination document subset based on the interest population criteria, similar to the method described in operation 306 of FIG. 3.

As shown by operation 812, the apparatus 200 includes means, such as processor 202, memory 204, communications hardware 206, insight engine 208, or the like, for generating a reference population overlap n-gram pair combination document subset. The insight engine 208 may identify and determine which documents within the overlap document n-gram pair document subset correspond to the reference population and then may generate the reference population overlap n-gram pair combination document subset to include these identified documents. The insight engine 208 may identify or otherwise determine which documents in the overlap n-gram pair document subset to include in the reference population overlap n-gram pair combination document subset based on the reference population criteria, similar to the method described in operation 308 of FIG. 3.

As shown by operation 814 in FIG. 8B, the apparatus 200 includes means, such as processor 202, memory 204, communications hardware 206, insight engine 208, or the like, for determining an interest population n-gram pair combination ratio for the interest population for each n-gram pair combination included in the n-gram pair combination set. The insight engine 208 may be configured to determine an interest population n-gram pair combination ratio for the interest population using the interest population overlap n-gram pair combination document subset, similar to operation 402 of FIG. 4. The interest population n-gram pair combination ratio may be indicative of a prevalence of the n-gram terms of the n-gram pair combination within the documents of the interest population. In some embodiments, the interest population n-gram pair combination ratio for the n-gram pair combination may be stored and used as a metric for the corresponding n-gram pair combination.

The insight engine 208 may determine the interest population n-gram pair combination ratio for a given n-gram pair combination based on an interest population overlap n-gram pair combination document count and an interest population overlap n-gram pair combination frequency count determined for that n-gram pair combination. The interest population overlap n-gram pair combination document count may be indicative of a number of documents included in the interest population overlap n-gram pair combination document subset. The interest population overlap n-gram pair combination frequency count may be indicative of a frequency count of a number of times the n-gram terms of the n-gram pair combination appeared in the documents of the interest population overlap n-gram pair combination document subset.

In some embodiments, the insight engine 208 may determine the interest population n-gram pair combination ratio by using the interest population overlap n-gram pair combination frequency count as the dividend and the interest population overlap n-gram pair combination document count as the divisor to yield a quotient that is the interest population n-gram pair combination ratio (e.g., interest population overlap n-gram pair combination frequency count divided by interest population overlap n-gram pair combination document count to yield the interest population n-gram pair combination ratio).

As shown by operation 816 in FIG. 8B, the apparatus 200 includes means, such as processor 202, memory 204, communications hardware 206, insight engine 208, or the like, for determining a reference population n-gram pair combination ratio for the reference population for each n-gram pair combination included in the n-gram pair combination set. The insight engine 208 may be configured to determine a reference population n-gram pair combination ratio for the reference population using the reference population overlap n-gram pair combination document subset, similar to operation 404 of FIG. 4. The reference population n-gram pair combination ratio may be indicative of a prevalence of the n-gram terms of the n-gram pair combination within the documents of the reference population. In some embodiments, the reference population n-gram pair combination ratio for the n-gram pair combination may be stored and used as a metric for the corresponding n-gram pair combination.

The insight engine 208 may determine the reference population n-gram pair combination ratio for a given n-gram pair combination based on a reference population overlap n-gram pair combination document count and a reference population overlap n-gram pair combination frequency count determined for that n-gram pair combination. The reference population overlap n-gram pair combination document count may be indicative of a number of documents included in the reference population overlap n-gram pair combination document subset. The reference population frequency count may be indicative of a frequency count of a number of times the n-gram terms of the n-gram pair combination appeared in the documents of the reference population overlap n-gram pair combination document subset.

In some embodiments, the insight engine 208 may determine the reference population n-gram pair combination ratio by using the reference population overlap n-gram pair combination frequency count as the dividend and the reference population overlap n-gram pair combination document count as the divisor to yield a quotient that is the reference population n-gram pair combination ratio (e.g., reference population overlap n-gram pair combination frequency count divided by reference population overlap n-gram pair combination document count to yield the reference population n-gram pair combination ratio).

As shown by operation 818, the apparatus 200 includes means, such as processor 202, memory 204, communications hardware 206, insight engine 208, or the like, for determining a n-gram pair combination topic lift for each n-gram pair combination included in the n-gram pair combination set. Once the insight engine 208 has determined an interest population n-gram pair combination ratio and a reference population n-gram pair combination ratio, the insight engine 208 may then determine a n-gram pair combination topic lift for the n-gram combination, similar to operation 406 of FIG. 4.

In particular, the insight engine may determine the n-gram pair combination topic lift for the n-gram combination based on the associated interest population n-gram pair combination ratio and the reference population n-gram pair combination ratio. In particular, the insight engine 208 may determine the n-gram pair combination topic lift for the n-gram term using equation 10 as follows:

$$n - gram pair comb topic lift = \frac{( int pop np comb ratio - ref pop np comb ratio )}{ref pop np comb ratio} \qquad ( 10 )$$

where, “comb” is abbreviated for combination, “pop” is abbreviated for population, “int” is abbreviated for interest, “ref” is abbreviated for reference, and “np” is abbreviated for n-gram pair in the above.

As shown by operation 820, the apparatus 200 includes means, such as processor 202, memory 204, communications hardware 206, insight engine 208, or the like, for determining whether one or more n-gram pair combination thresholds are satisfied for each n-gram pair combination in the n-gram pair combination set. As described above, the one or more configuration parameters initialized by the insight engine 208 may include one or more filters. In some embodiments, the one or more filters may provide one or more rules which n-gram pair combinations must satisfy in order to be considered for topic consolidation. In some embodiments, the one or more filters may describe conditions, such as one or more n-gram pair combination thresholds, that each n-gram pair combination needs to satisfy to be further processed by the insight engine for topic consolidation. The one or more n-gram pair combination thresholds described by the one or more filters may relate to metric thresholds, such as an associated interest population overlap n-gram pair combination document count threshold, an interest population overlap n-gram pair combination frequency count threshold, reference population overlap n-gram pair combination document count threshold, a reference population overlap n-gram pair combination frequency count threshold, an interest population n-gram pair combination ratio threshold, reference n-gram pair combination ratio threshold, and/or n-gram pair combination topic lift threshold which the n-gram pair combination must satisfy in order to be considered to topic consolidation. This helps to ensure that the n-gram pair combination is still significant when the n-gram pairs are combined.

In an instance the n-gram pair combination fails to satisfy the one or more n-gram pair combination thresholds, the insight engine 208 may proceed to operation 822. As shown by operation 822, the apparatus 200 includes means, such as processor 202, memory 204, communications hardware 206, insight engine 208, or the like, for determining to not generate a topic identifier for the n-gram pair combination. In particular, if the n-gram pair combination fails to satisfy the one or more n-gram pair combination thresholds, the insight engine 208 may determine that the particular n-gram pair combination is no longer significant when the n-gram pairs are combined together and thus, a single topic identifier should not be assigned to the n-gram pair combination. As such, the n-gram pairs of the n-gram pair combination may maintain their respective topic identifiers.

In an instance the n-gram pair combination satisfies the one or more n-gram pair combination thresholds, the insight engine 208 may proceed to operation 824. As shown by operation 824, the apparatus 200 includes means, such as processor 202, memory 204, communications hardware 206, insight engine 208, or the like, for determining an interest population n-gram pair combination score for the n-gram pair combination. In an instance the n-gram pair combination satisfies the one or more n-gram pair combination thresholds, the insight engine 208 may determine that the particular n-gram pair combination maintains its significance when the n-gram pairs are combined together and thus, the n-gram pair combination should be considered to determine whether a single topic identifier should be used for the n-gram pairs.

As such, the insight engine 208 may generate an interest population n-gram pair combination score for the n-gram pair combination. The interest population n-gram pair combination score for the n-gram pair combination may be indicative of the co-occurrence of the n-gram pairs of the n-gram pair combination together within the interest population. In particular, the insight engine 208 may determine an overall interest population n-gram pair combination 1 count indicative of the number of documents within the interest population overlap n-gram pair combination document subset that include the n-gram terms of the first n-gram pair of the n-gram pair combination (e.g., n-gram pair combo 1), an overall interest population n-gram pair combination 2 count indicative of the number of documents within the interest population overlap n-gram pair combination document subset that include the n-gram terms of the second n-gram pair of the n-gram pair combination (e.g., n-gram pair combo 2), and an overall interest population n-gram pair combination both count indicative of the number of documents within the interest population overlap n-gram pair combination document subset that include the n-gram terms of the first n-gram pair and second n-gram pair of the n-gram pair combination (e.g., n-gram pair combo both). Then, the insight engine 208 may determine the interest population n-gram pair score using equation 11 as follows:

$$int pop np combination score = \frac{( np combo both * np combo both )}{( np combo 1 * np combo 2 )} \qquad ( 11 )$$

where, “int” is used as an abbreviation for interest, “pop” is used as an abbreviation for population, and “np” is used as an abbreviation for n-gram pair in the above.

As shown by operation 826, the apparatus 200 includes means, such as processor 202, memory 204, communications hardware 206, insight engine 208, or the like, for generating an interest population n-gram pair combination confidence for each n-gram pair combination in the n-gram pair combination set which satisfied the one or more n-gram pair combination thresholds. Once the insight engine 208 determines the interest population n-gram pair combination score for the n-gram pair combination, the insight engine 208 may further determine an interest population n-gram pair combination confidence for the n-gram pair combination. The interest population n-gram pair combination confidence for a n-gram pair combination may be indicative of an overall reliability associated with the interest population n-gram pair combination score. Said otherwise, the interest population pair confidence score for a n-gram pair combination may be indicative of an overall reliability of an inferred correlation between the n-gram pairs included in the n-gram pair combination.

In particular, the insight engine 208 may use the overall interest population n-gram pair combination 1 count and overall interest population n-gram pair combination both count for the n-gram pair combination. The insight engine 208 may determine the interest population n-gram pair combination confidence using equation 12 as follows:

$$int pop n - gram pair combination confidence = \frac{( n - gram pair combo both )}{( n - gram pair combo 1 )} \qquad ( 12 )$$

where, “int” is used as an abbreviation for interest and “pop” is used as an abbreviation for population in the above.

As shown by operation 824, the apparatus 200 includes means, such as processor 202, memory 204, communications hardware 206, insight engine 208, or the like, for determining whether one or more topic thresholds are satisfied for the one or more n-gram pair combinations which satisfied the n-gram pair combination thresholds. As described above, the one or more configuration parameters initialized by the insight engine 208 may include one or more filters. In some embodiments, the one or more filters may provide one or more rules which n-gram pair combinations must satisfy in order to be consolidated into the same topic identifier. In some embodiments, the one or more filters may describe conditions, such as one or more n-gram topic thresholds, that each n-gram pair combination needs to satisfy to qualify for topic consolidation. The one or more topic thresholds described by the one or more filters may relate to metric thresholds, such as an associated interest population n-gram pair combination score, an interest population n-gram pair combination confidence, and/or the like, which the n-gram pair combination must satisfy in order for the n-gram pairs of the n-gram pair combination to be consolidated into a single topic identifier.

In an instance the n-gram pair combination fails to satisfy the one or more topic thresholds, the insight engine 208 may proceed to operation 826. As shown by operation 826, the apparatus 200 includes means, such as processor 202, memory 204, communications hardware 206, insight engine 208, or the like, for determining to not generate a topic identifier for the n-gram pair combination. In particular, if the n-gram pair combination fails to satisfy the one or more topic thresholds, the insight engine 208 may determine that a correlation between the n-gram pairs of the n-gram pair combination is not significant enough to warrant consolidation and thus, a single topic identifier should not be assigned to the n-gram pair combination. As such, the n-gram pairs of the n-gram pair combination may maintain their respective topic identifiers.

In an instance the n-gram pair combination satisfies the one or more topic thresholds, the insight engine 208 may proceed to operation 828. As shown by operation 828, the apparatus 200 includes means, such as processor 202, memory 204, communications hardware 206, insight engine 208, or the like, for generating a topic identifier for the n-gram pair combination. In particular, if the n-gram pair combination is determined to satisfy the one or more topic thresholds, the insight engine 208 may determine that a correlation between the n-gram pairs of the n-gram pair combination is significant enough to warrant consolidation and thus, a single topic identifier should be assigned to the n-gram pair combination. Thus, a single topic identifier may be generated for the n-gram pairs of the n-gram pair combination. The topic identifier may also be associated with the one or more metrics determined for the n-gram pair combinations, such as the interest population n-gram pair combination score, interest population n-gram pair combination confidence, and/or the like.

In some embodiments, the n-gram pairs of the n-gram pair combination may have each been previously assigned a topic identifier. Since the n-gram pairs have now been determined to be highly correlated by the insight engine 208, both n-gram pairs may be assigned a single topic identifier and the insight engine may delete the previous topic identifiers associated with the respective n-gram pairs. The topic identifier for the n-gram pair combination may still include one or more metrics determined for each n-gram pair of the n-gram pair combination, such as an interest population n-gram pair score, reference population n-gram pair score, interest population pair confidence, reference population pair confidence, n-gram pair lift, n-gram pair confidence lift, and/or the like. Additionally, the topic identifier for the n-gram pair combination may still include one or more metrics determined for each n-gram term of the n-gram pairs, such as the interest population n-gram frequency count, the reference population n-gram frequency count, interest population n-gram term ratio, reference population n-gram term ratio, n-gram ratio lift, weighted n-gram ratio lift, and/or the like for n-gram terms of the n-gram pairs.

In some embodiments, once the n-gram pair combination is assigned the same topic identifier, the insight engine 208 may consider the n-gram pair combination to be a n-gram pair and may perform operations 802 through 828 for this n-gram pair with another n-gram pair. As such, the insight engine 208 may determine highly correlated n-gram terms without a size restriction such that a topic identifier may be associated with any number of n-gram terms associated with n-gram pairs determined to satisfy the n-gram pair combination thresholds and topic thresholds.

Returning now to FIG. 3, as shown by operation 314, the apparatus 200 includes means, such as processor 202, memory 204, communications hardware 206, insight engine 208, or the like, for generating an emerging topic set for an interest population. As described above, the insight engine 208 may generate topic identifiers for n-gram terms, n-gram pairs, and/or n-gram pair combinations via the streamline n-gram routine of operation 312. Once the insight engine 208 has generated the various topic identifiers, the insight engine 208 may then generate an emerging topic set which includes one or more topics corresponding to the generated topic identifiers. Each topic identifier may thus be associated with one or more n-gram terms. For example, a topic identifier for a n-gram term that was not determined to have high correlation with other n-gram terms may include only one associated n-gram term, a topic identifier for a n-gram pair which was determined to have high correlation between the n-gram terms included in the n-gram pair but not other n-gram pairs may include two associated n-gram terms, and a topic identifier for a n-gram pair combination may include three of more n-gram terms. These topic identifiers may all be included in the emerging topic set for an interest population and further processed as described below.

As shown by operation 316, the apparatus 200 includes means, such as processor 202, memory 204, communications hardware 206, insight engine 208, or the like, for generating a per-topic metric set for each topic included in the emerging topic set. Once the emerging topic set is generated and includes one or more topic identifiers, a per-topic metric set may be generated for each topic identifier. This per-topic metric set may include one or more metrics of interest for the topic identifier such that these metrics may be included in an insight report and viewable by one or more entity personnel. Each per-topic metric set may include one or more per-topic metrics for the corresponding topic identifier based on the one or more n-gram terms associated with the topic identifier. In some embodiments, the one or more configuration parameters initialized by the insight engine 208 may describe the one or more per-topic metrics to be included in the per-topic metric set. In some embodiments, the one or more per-topic metrics included in the per-topic metric set may be associated with the n-gram term, n-gram pair, and/or n-gram pair combination as described above in FIGS. 4, 6, and 8A-8B.

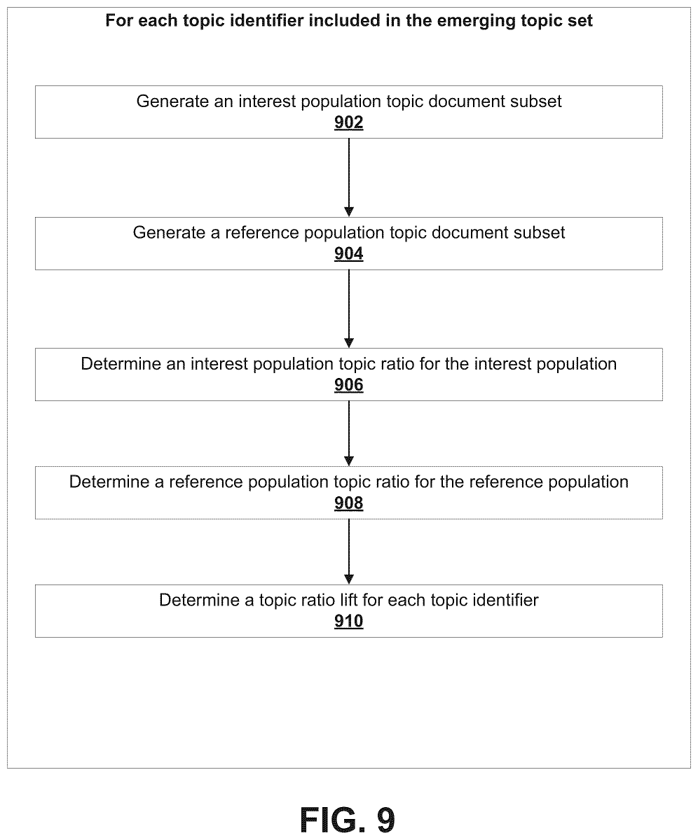

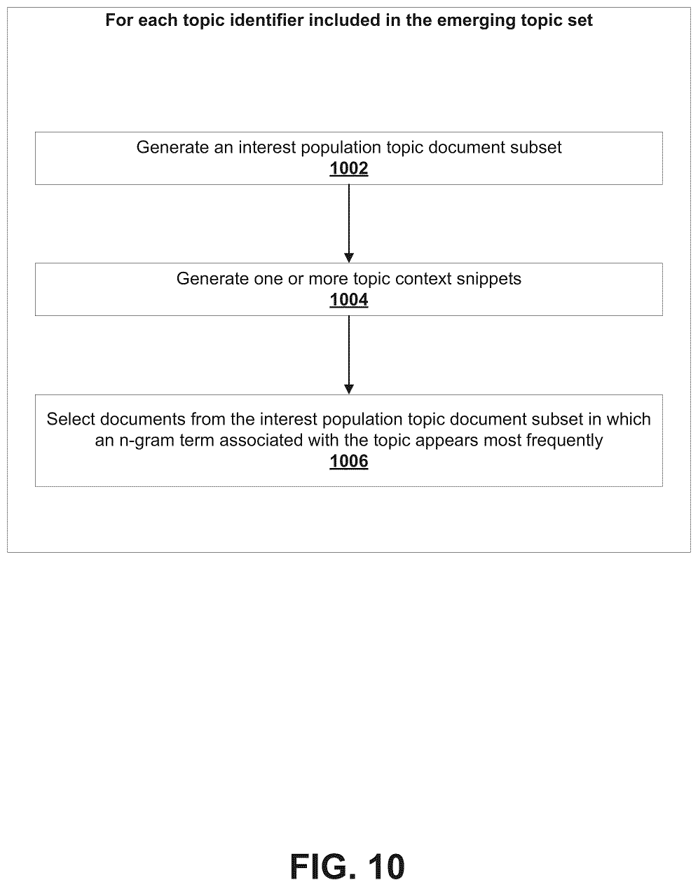

In some embodiments, operation 316 may be performed in accordance with the operations described by FIGS. 9-10. Via the various operations performed in FIGS. 9 and/or 10, one or more per-topic metrics may be generated for a topic identifier.

Turning first to FIG. 9, operations are shown for determining a ratio lift for each topic identifier in the emerging topic set. As shown by operation 902, the apparatus 200 includes means, such as processor 202, memory 204, communications hardware 206, insight engine 208, or the like, for generating an interest population topic document subset for each topic identifier included in the emerging topic set. In order to generate per-topic metrics for a topic identifier, the insight engine 208 may identify and determine which documents within the interest population document subset include the one or more n-gram terms associated with the topic identifier and then may generate the interest population topic document subset to include these identified documents. As such, the interest population topic document subset may refine the interest population topic document set to include only the documents which include one or more of the n-gram terms associated with the topic identifier and may exclude documents of the interest population document subset which do not include the n-gram terms associated with the topic identifier.

In some embodiments, a document must include each n-gram term that is associated with a topic identifier in order to be included in the interest population topic document subset. In some embodiments, a document must only include one n-gram term that is associated with a topic identifier in order to be included in the interest population document subset. As such, the interest population topic document subset may refine the documents pertaining to the interest population to only those documents which include the n-gram terms associated with the topic identifier, which allows the insight engine 208 to reduce the number of documents which need processing to only the documents relevant to the topic identifier.

As shown by operation 904, the apparatus 200 includes means, such as processor 202, memory 204, communications hardware 206, insight engine 208, or the like, for generating a reference population topic document subset for each topic identifier included in the emerging topic set. In order to generate per-topic metrics for a topic identifier, the insight engine 208 may identify and determine which documents within the reference population document subset include the one or more n-gram terms associated with the topic identifier and then may generate the reference population topic document subset to include these identified documents. As such, the reference population topic document subset may refine the reference population topic document set to include only the documents which include one or more of the n-gram terms associated with the topic identifier and may exclude documents of the reference population document subset which do not include the n-gram terms associated with the topic identifier.

In some embodiments, a document must include each n-gram term that is associated with a topic identifier in order to be included in the reference population topic document subset. In some embodiments, a document must only include one n-gram term that is associated with a topic identifier in order to be included in the reference population document subset. As such, the reference population topic document subset may refine the documents pertaining to the reference population to only those documents which include the n-gram terms associated with the topic identifier, which allows the insight engine 208 to reduce the number of documents which need processing to only the documents relevant to the topic identifier.

As shown by operation 906, the apparatus 200 includes means, such as processor 202, memory 204, communications hardware 206, insight engine 208, or the like, for determining an interest population topic ratio for the interest population for each topic identifier. The insight engine 208 may be configured to determine an interest population topic ratio for the interest population using the interest population topic document subset. The interest population topic ratio may be indicative of a prevalence of the n-gram terms associated with the topic identifier within the documents of the interest population. The interest population topic ratio for the topic identifier may be stored and used as a metric for the corresponding topic identifier.

The insight engine 208 may determine the interest population topic ratio for a given topic identifier based on an interest population topic document count and an interest population topic frequency count determined for the topic identifier and based on the n-gram terms associated with the topic identifier. The interest population topic document count may be indicative of a number of documents included in the interest population topic document subset. The interest population topic frequency count may be indicative of a frequency count of a number of times a n-gram term associated with the topic identifier appeared in the documents of the interest population topic document subset. Said otherwise, the interest population topic frequency count is indicative of the number of times a n-gram term associated with the topic identifier appeared within the entirety of the interest population topic document subset.

In some embodiments, the insight engine 208 may determine the interest population topic ratio by using the interest population topic frequency count as the dividend and the interest population topic document count as the divisor to yield a quotient that is the interest population topic ratio (e.g., interest population topic frequency count divided by interest population topic document count to yield the interest population topic ratio).

As shown by operation 908, the apparatus 200 includes means, such as processor 202, memory 204, communications hardware 206, insight engine 208, or the like, for determining a reference population topic ratio for the reference population for each topic identifier. The insight engine 208 may be configured to determine a reference population topic ratio for the reference population using the reference population topic document subset. The reference population topic ratio may be indicative of a prevalence of the n-gram terms associated with the topic identifier within the documents of the reference population. The reference population topic ratio for the topic identifier may be stored and used as a metric for the corresponding topic identifier.

The insight engine 208 may determine the reference population topic ratio for a given topic identifier based on a reference population topic document count and a reference population topic frequency count determined for the topic identifier and based on the n-gram terms associated with the topic identifier. The reference population topic document count may be indicative of a number of documents included in the reference population topic document subset. The reference population topic frequency count may be indicative of a frequency count of a number of times a n-gram term associated with the topic identifier appeared in the documents of the reference population topic document subset. Said otherwise, the reference population topic frequency count is indicative of the number of times a n-gram term associated with the topic identifier appeared within the entirety of the reference population topic document subset.

In some embodiments, the insight engine 208 may determine the reference population topic ratio by using the reference population topic frequency count as the dividend and the reference population topic document count as the divisor to yield a quotient that is the reference population topic ratio (e.g., reference population topic frequency count divided by reference population topic document count to yield the reference population topic ratio).

As shown by operation 910, the apparatus 200 includes means, such as processor 202, memory 204, communications hardware 206, insight engine 208, or the like, for determining a topic ratio lift for each topic identifier included in the emerging topic set. Once the insight engine 208 has determined an interest population topic ratio and a reference population topic ratio, the insight engine 208 may then determine a topic ratio lift for the topic identifier. The topic ratio lift for the topic identifier may be indicative of a relative rise in the usage or frequency of the topic (e.g., based on the associated n-gram terms) in the interest population with respect to the reference population and thus, may indicative whether that the topic has shifted in significance within the given interest population. In some embodiments, the topic ratio lift for the topic identifier may be stored and used as a metric for the corresponding topic identifier. In some embodiments, the insight engine may use the topic ratio lift determined for each topic identifier to rank order the topic identifiers relative to one another.

In particular, the insight engine may determine the topic ratio lift for the topic identifier based on the associated interest population topic ratio and the reference population topic ratio. In particular, the insight engine 208 may determine the topic ratio lift for the topic identifier using equation 13 as follows:

$$topic ratio lift = \frac{( interest population topic ratio - reference population topic ratio )}{reference population topic ratio} \qquad ( 13 )$$

The insight engine 208 may then use one or more of the above-described metrics, such as the interest population topic ratio, reference population topic ratio, topic ratio lift, and/or the like to generate the one or more per-topic metrics for the topic identifier.

Turning now to FIG. 10, operations are shown for generating one or more topic context snippets and/or documents for each topic identifier included in the emerging topic set. The one or more context snippets and/or documents generated via the operations of FIG. 10 may be included as one or more per-topic metrics in the per-topic metric set for a particular topic identifier.

As shown by operation 1002, the apparatus 200 includes means, such as processor 202, memory 204, communications hardware 206, insight engine 208, or the like, for generating an interest population topic document subset for each topic identifier included in the emerging topic set. Operation 1002 may be performed substantially similar to operation 902 as described above.

As shown by operation 1004, the apparatus 200 includes means, such as processor 202, memory 204, communications hardware 206, insight engine 208, or the like, for generating one or more topic context snippets for each topic identifier included in the emerging topic set. The insight engine 208 may generate one or more context snippets for a topic identifier based on the one or more n-grams associated with the topic identifier and using the interest population topic document subset. The one or more context snippets may be included as per-topic metrics within the per-topic metric set and may provide an entity personnel with document context regarding the usage of the n-gram terms within the document. The insight engine 208 may also identify a threshold number of preceding terms occurring sequentially before the n-gram term and a threshold number of succeeding terms occurring sequentially after the n-gram term. The insight engine 208 may then generate the context snippet by combining the preceding terms, the n-gram term, and the succeeding terms. The one or more configuration parameters initialized by the insight engine 208 may control the value of the number of preceding terms and the number of succeeding terms include in the context snippets.

For example, a topic identifier may be associated with the n-gram term “double charge”. As such, the insight engine 208 may identify an instance of the n-gram term “double charge” within a document of the interest population topic document subset and may further identify a set number of terms that occur before “double charge” and a set number of terms that occur after “double-charge”. By way of particular example, a snippet of a document within the interest population topic document subset may read “I visited store XYZ yesterday and I believe I received a double charge for my purchase. I wanted to call to resolve this issue”. If the one or more configuration parameters describe a number of preceding terms as 4 and a number of succeeding terms as 4, the insight engine may then generate a context snippet of “ . . . believe I received a double charge for my purchase. I . . . ”.

As shown by operation 1006, the apparatus 200 includes means, such as processor 202, memory 204, communications hardware 206, insight engine 208, or the like, for selecting documents from the interest population topic document subset in which a n-gram term associated with the topic appears most frequently for each topic included in the emerging topic set. In some embodiments, the insight engine 208 may process each document within the interest population topic document subset to determine a set number of documents in which the n-gram terms associated with the topic identifier occur most frequently. The one or more configuration parameters initialized by the insight engine 208 may control the number of documents select for each topic identifier. The one or more selected documents may be included as per-topic metrics within the per-topic metric set and may provide an entity personnel with a full-length document for each topic identifier.

Returning now to FIG. 3, optionally, as shown by operation 318, the apparatus 200 includes means, such as processor 202, memory 204, communications hardware 206, insight engine 208, or the like, for assigning a group identifier to topic identifiers included in the emerging topic set. Although n-gram terms of a topic identifier may have been determined to not be correlated enough to be included within the same topic identifier, these n-gram terms may still be partially correlated and the insight engine 208 may convey this less significant correlation using a group identifier. In some embodiments, the insight engine 208 may assign a same group identifier to each topic identifier which includes one or more of the same associated n-gram terms. For example, a first topic identifier may be associated with a n-gram terms of “double-charge” and “notification” and a second topic identifier may be associated with a n-gram term of “double-charge” and “store XYZ”. Thus, the insight engine 208 may generate and assign a same group identifier to the first topic identifier and second topic identifier.

As shown by operation 320, the apparatus 200 includes means, such as processor 202, memory 204, communications hardware 206, insight engine 208, or the like, for generating an insight report. The insight engine 208 may generate the insight report based on the per-topic metric set for each topic identifier in the emerging topic set. In particular, the insight report may include each per-topic metric set for each topic identifier included in the emerging topic set. As such, one or more entity personnel who view the insight report may be able to gain insight into emerging topics in real-time and therefore can take appropriate corrective action if needed. Additionally, the insight engine 208 may generate the insight report based on an associated topic ratio lift for each topic identifier. For example, the topic identifier associated with the highest topic ratio lift may be included first in the insight report, followed by the topic identifier associated with eh second highest topic ratio lift, and so forth until all the topic identifiers are included in the insight report.

In some embodiments, the insight engine 208 may query a topic dictionary to determine if a particular topic has been previously generated from a historical run. The topic dictionary may include a topic description, that may be generated by SME or other entity personnel. Additionally, a topic dictionary may store historical metrics related to historically identified topics. In an instance the insight engine 208 determines the topic is include in the topic dictionary, the insight engine 208 may include information from the topic dictionary in the insight report. In some embodiments, the insight engine 208 may query the topic dictionary using the associated n-gram terms of the topic identifier. In an instance an exact n-gram term match is found in the topic dictionary, the insight engine 208 may determine the current topic identifier is the same topic as the topic found in the topic dictionary. In some embodiments, the insight engine 208 may update the topic identifier in the emerging topic set to match the topic identifier. The insight engine 208 may also update the topic dictionary to include the one or more metrics determined from the current run. As such, the topic dictionary may be kept up to date and accurate.

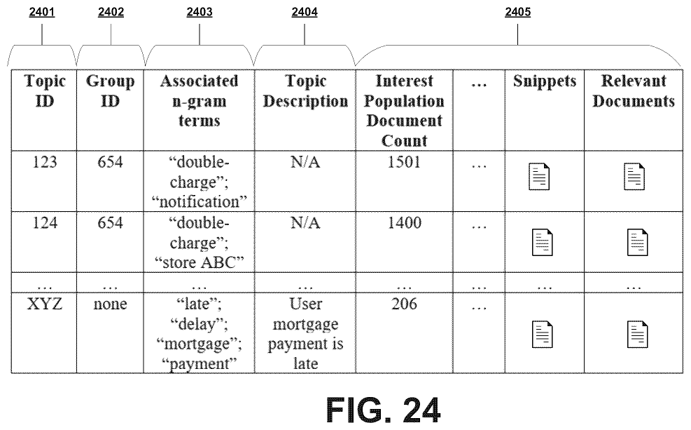

FIG. 24 illustrates an example insight report which may be generated and provided in some embodiments. In particular, FIG. 24 illustrates an example graphical user interface (GUI) that illustrates an example insight report. As noted previously, an entity personnel may interact with the insight analytics system 102 by directly engaging with communications hardware 206 of an apparatus 200 comprising a system device of the insight analytics system 102. In such an embodiment, the GUI shown in FIG. 24 may be displayed to an entity personnel by the apparatus 200. Alternatively, an entity personnel may interact with the insight analytics system 102 using a separate facility device (e.g., any of facility devices 108A-108N, as shown in FIG. 1), which may communicate with the insight analytics system 102 via communications network 104. In such an embodiment, the GUI shown in FIG. 24 may be displayed to the entity personnel by the facility device 108A-108N.

As shown in FIG. 24, the topic insight report may include the topic identifiers (e.g., topic IDs) 2401, which may be ranked based on an associated topic ratio lift. The insight report may also include a group identifier 2402 for each topic identifier, if applicable. The insight report may also include the one or more associated n-gram terms 2403 for the topic identifier. Additionally, the insight report may include one or more per-topic metrics 2405 from the per-topic metric set. In some embodiments, the insight report may further include information from the topic dictionary 2404. As such, an entity personnel may view the insight report to glean an understanding of the current topics emerging for an interest population.

As shown by operation 322, the apparatus 200 includes means, such as processor 202, memory 204, communications hardware 206, or the like, for providing the insight report. Once the insight engine 208 generates the insight report, the communications hardware 206 may provide the insight report to one or more facility devices 108A-108N. As such, one or more entity personnel of the facility devices may view and the insight report and determine the one or more topics which are most significant for an interest population and if necessary, take corrective action to remedy currently experienced issues and/or prevent future issues from occurring.

In some embodiments, corrective action taken by recipients of the insight report may include providing one or more notifications to entity personnel determined to have been affected by a topic. For example, a topic associated with a topic identifier of the insight report may relate to entity users being double charge by a particular store. As such, the one or more recipient entity personnel of the insight report may begin an investigation into the topic, may identify compromised users and provide notifications to affected entity users alerting them that the issue is being investigated, may identify potential entity users who may be affected in the future and proactively alert them to the issue, and/or may alert entity users once a resolution has been implemented.

FIGS. 3, 4, 5, 6, 7, 8A-8B, 9, and 10 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Frameworks and Architectures for the Insight Analytics System using the Insight Engine

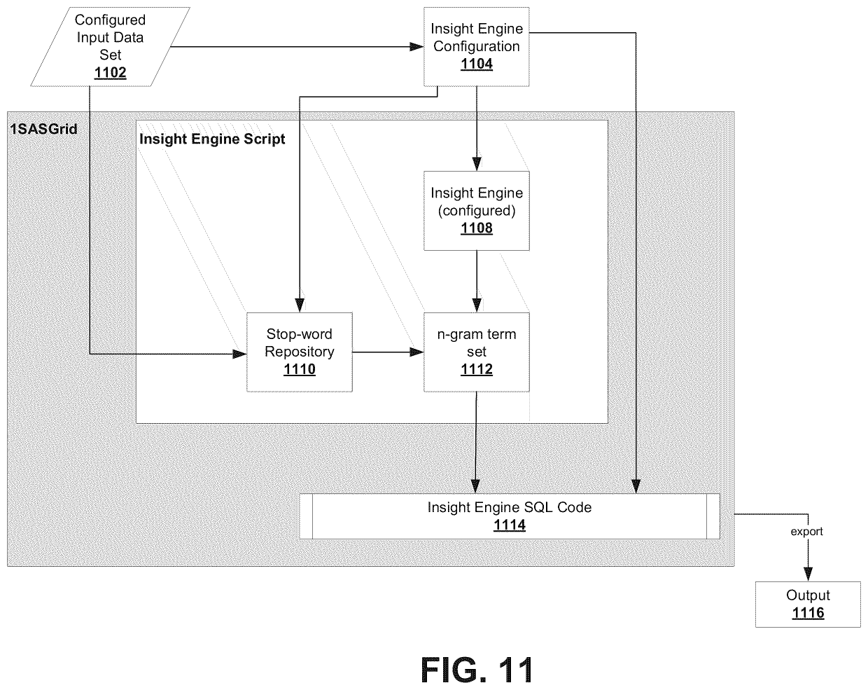

FIGS. 11-23 illustrate an example frameworks, architectures, and workflows that may be implements by the insight analytics system 102. Turning first to FIG. 11, an operational example of an insight engine workflow is illustrated. As shown in FIG. 11, a configured input data set 1102 may be received by the insight analytics system (not shown) and used for insight engine configuration 1104. Once configured, the insight engine (configured) 1108 may be used to generate an n-gram term set 1112. Additionally, a stop-word repository 1110 may be selected or accessed based on the insight engine configuration 1104 and/or configured input data set 1102. The n-gram term set 1112 may be filtered based on the stop-word repository 1110. The n-gram term set 1112 may then be passed to the insight engine structured query language (SQL) code 1114 within a SAS grid. The SAS grid may then export an output 1116. In some embodiments, the output is the emerging topic set and one or more per-topic metric sets for each topic identifier.

Turning now to FIG. 12, configuration parameters of a configured insight engine are shown. As will be appreciated by one of skill in the art, the one or more configuration parameters shown in FIG. 12 are merely example configuration parameters and any number of configuration parameters may be contemplated. The unique ID configuration parameter 1202 may describe an insight engine run identifier such that the particular run of the insight engine may be uniquely identified. The run type configuration parameters 1204 may describe a particular type of configuration engine run type. For example, in some embodiments, the insight engine run type may indicate a cross compare insight engine run type, a default insight engine run type, or a production insight engine run type. Each insight engine run type may be associated with a particular driver script, which may be determine various insight engine configuration parameters. A cross compare insight engine run type may describe operations to compare a single interest population to two or more reference populations, a default insight engine run type may describe operations to compare a single interest population to a single reference population, and a production insight engine run type may describe operations to compare a single interest population to a single reference population with additional execution conditions. The engine desc. 1 configuration parameter 1206 and engine desc. 2 configuration parameter 1208 may describe configuration parameters associated with the particular configurated insight engine. The source configuration parameter 1210 may describe the source document set. The conformed snap configuration parameter 1212 may describe the configuration parameters as received from the configured input data set.

The configuration parameters 1214-1240 may relate to various filters, which may be implemented to remove n-gram terms, n-gram pairs, n-gram pair combinations, etc. to ensure high quality data. The n-gram filter 1 configuration parameter 1214 may describe a minimum proportion of documents an n-gram term must occur within. The n-gram filter 2 configuration parameters 1216 may describe a maximum number of documents an n-gram term can occur within for a reference population. The n-gram filter 3 configuration parameters 1218 may describe a minimum number of documents which associated n-gram terms occur in. The filter 0 configuration parameter 1220 may describe a maximum number of n-gram terms that may be included in an n-gram payload. The filter 1 configuration parameter 1222 may describe that a maximum number of occurrences of an n-gram term within a portion of documents. The filter 2 configuration parameter 1224 may describe a minimum ratio lift for an n-gram term. The filter 3 configuration parameter 1226 may describe a minimum number of documents for an n-gram pair. The filter 4 configuration parameter 1228 may describe a minimum proportion of documents the second n-gram term of the n-gram must occur in. The filter 5 configuration parameter 1230 may describe a maximum number of topic identifiers for an emerging topic set. The filter 6 configuration parameter 1232 may describe a minimum proportion of documents associated n-gram terms of a topic identifier must occur within. The filter 7 configuration parameter 1234 may describe a minimum topic ratio lift for a n-gram term combination. The filter 8 configuration parameter 1236 may describe a minimum percent increase within an interest population group for a n-gram term combination. The filter 9 configuration parameter 1238 may describe a maximum number of topic identifiers ordered based on document size. The filter 10 configuration parameter 1240 may describe a maximum number of topic identifiers based on topic ratio lift. The topic filter configuration parameter 1242 may describe a maximum number of topic identifiers for an emerging topic set.

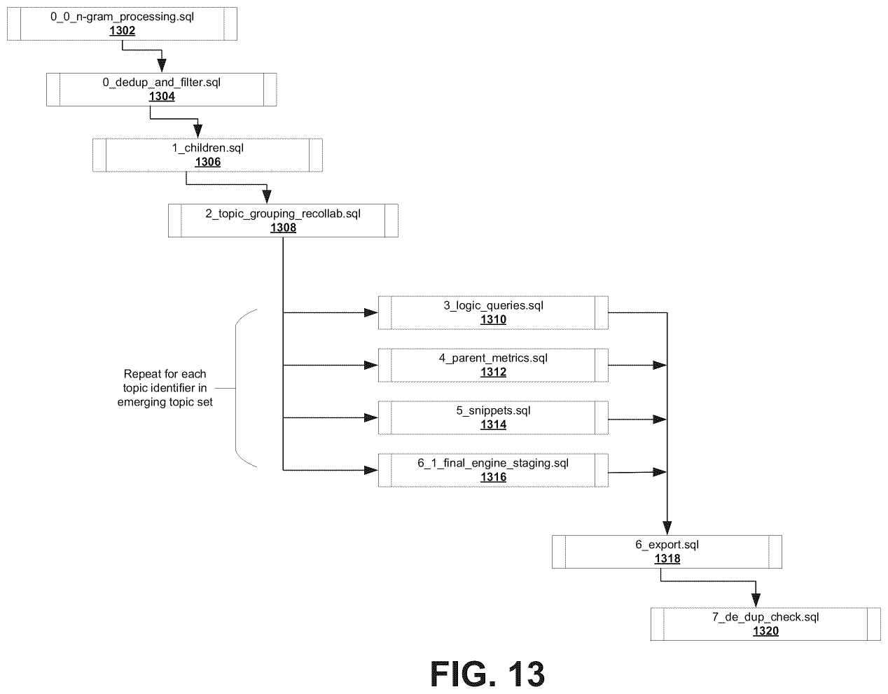

Turning now to FIG. 13, an overview of the various routines and/or operations performed by the insight engine is shown. The insight engine may perform a 0_0_n-gram_processing routine 1302, a 0_dedup_and_filter routine 1304, a 1_children routine 1306, and a 2_topic_grouping_recollab routine 1308 to generate a n-gram set and emerging topic set. The insight engine may additionally perform a 3_logic_queries routine 1310, 4_parent_metrics routine 1312, 5_snippets routine 1314, and 6_1_final_engine_staging routine 1316 for each topic identifier in the emerging topic set. In some embodiments, the insight engine may use parallel processing to simultaneously process each topic identifier using routines 1310-1316. As such, the insight engine may efficiently process each topic identifier in a time manner. Additionally, the insight engine may perform a 6_export routine 1318 and 7_de_dup_check routine 1320. The individual operations performed for each routine will be described below.

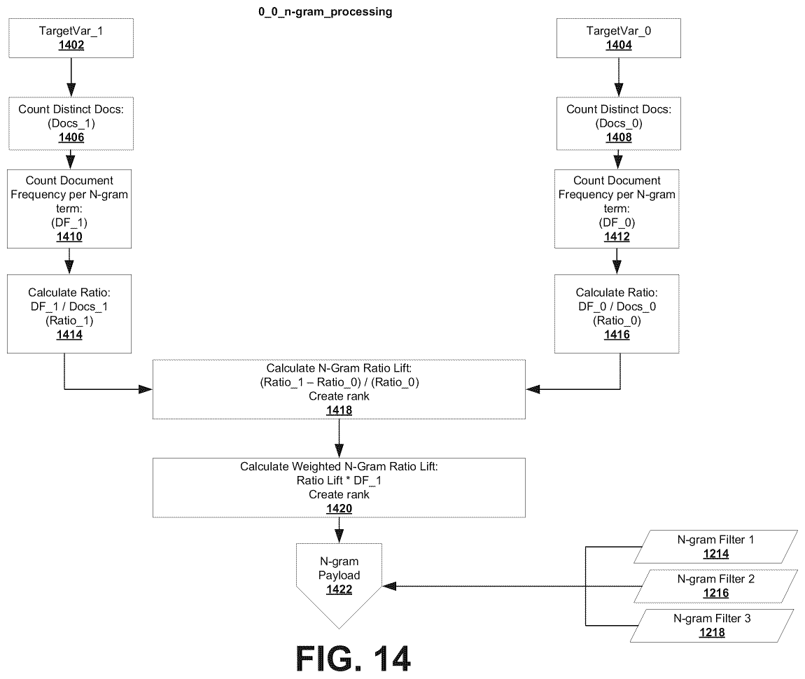

Turning now to FIG. 14, operations of the 0_0_n-gram_processing routine 1302 are illustrated. The insight engine may identify documents for targetvar_1 at operation 1402 (e.g., an interest population) and documents for targetvar_2 at operation 1404 (e.g., a reference population). Then the insight engine may determine Docs_1 at operation 1406 (e.g., an interest population document count) and Docs_0 at operation 1408 (e.g., reference population document count) variables. The insight engine may also determine a DF_1 at operation 1410 (e.g., interest population n-gram frequency count) and a DF_0 at operation 1412 (e.g., reference population n-gram frequency count) for each n-gram term. Then the insight engine may determine a ratio_1 at operation 1414 (e.g., interest population n-gram term ratio) and a ratio_0 at operation 1416 (e.g., reference population n-gram term ratio) for the n-gram terms. The insight engine may then calculate a n-gram ratio lift at operation 1418 and weighted n-gram ratio lift at operation 1420 to generate the n-gram payload 1422. The insight engine may apply n-gram filter 1 1214, n-gram filter 2 1216, and n-gram filter 3 1216 to the n-gram payload 1422 to refine the n-gram payload 1422.

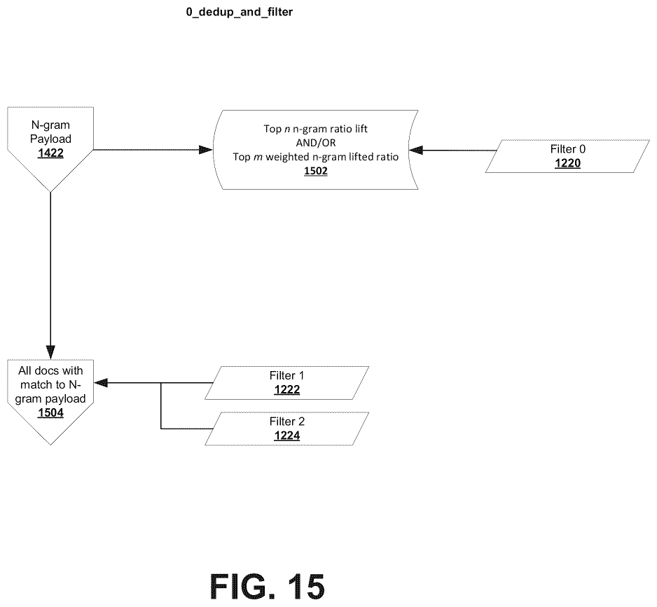

Turning now to FIG. 15, example operations of the 0_dedup_and_filter routine 1304 are illustrated. The insight engine may apply filter 0 1220 to the n-gram payload 1422 to generate a set number n n-gram terms associated with the highest n-gram term ratio lift and/or a set number m n-gram terms associated with the highest weighted n-gram term ratio lift. Additionally, the insight engine may identify all documents which match the n-gram payload and apply filters 1 and 2 to further refine the n-gram payload 1422.

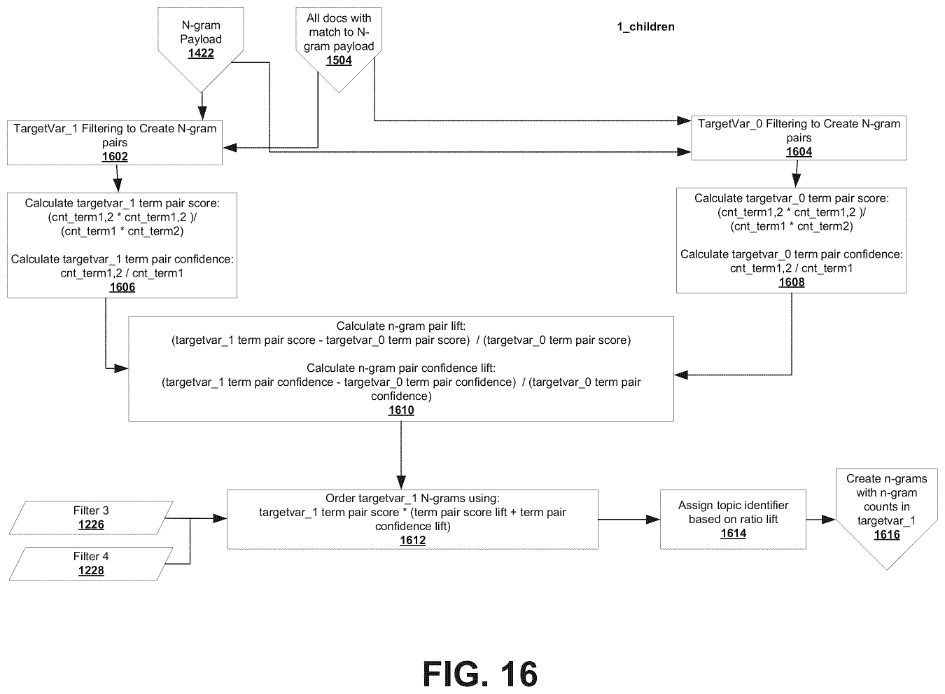

Turning now to FIG. 16, example operations of the 1_children routine 1306 are illustrated. The insight engine may generate n-gram pairs for a targetvar_1 at operation 1602 (e.g., interest population) and targetvar_0 at operation 1604 (e.g., reference population). The insight engine may calculate a targetvar_1 term pair score (e.g., interest population n-gram pair score) for each n-gram pair in the n-gram pair set and a targetvar_1 par confidence (e.g., interest population pair confidence) at operation 1606. The insight engine may calculate a targetvar_0 term pair score (e.g., reference population n-gram pair score) for each n-gram pair in the n-gram pair set and a targetvar_0 par confidence (e.g., reference population pair confidence) at operation 1608. The insight engine may then determine n-gram pair lift and n-gram pair confidence lift at operation 1610. The insight engine may order the n-gram pairs at operation 1612. The insight engine may apply filter 3 1226 and filter 4 1228 to the n-gram pairs and assign a topic identifier based on a n-gram pair ratio lift for the n-gram pairs to generate n-grams with n-gram count in targetvar_1 1616 (e.g., n-gram pair payload).

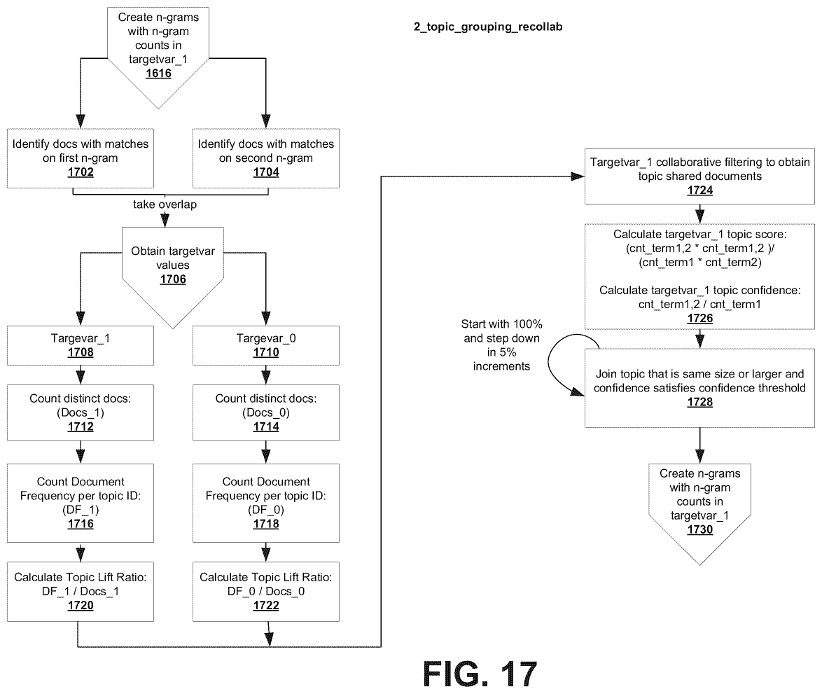

Turning now to FIG. 17, example operations of the 2_topic_grouping_recollab routine 1308 are illustrated. The insight engine may identify document matches using a first n-gram pair at operation 1702 and identify document matches using a second n-gram pair at operation 1704. The insight engine may take the document overlap to generate the targetvar values 1706 (e.g., overlap n-gram pair document subset). The insight engine may then identify the targetvar_1 (e.g., interest population) at operation 1708 and the targetvar_0 (e.g., reference population) at operation 1710 from the targetvar values 1706. The insight engine may determine Docs_1 at operation 1712 (e.g., interest population overlap n-gram pair combination document count) and Docs_0 at operation 1714 (e.g., reference population overlap n-gram pair combination document count) variables. The insight engine may also determine a DF_1 at operation 1716 (e.g., interest population overlap n-gram pair combination frequency count) and a DF_0 at operation 1718 (e.g., reference population overlap n-gram pair combination frequency count) for each n-gram term. Then the insight engine may determine a topic lift ratio at operation 1720 (e.g., interest population n-gram pair combination ratio) and a ratio_0 at operation 1722. (e.g., reference population n-gram pair combination ratio) for a n-gram pair combination. The insight engine may then filter the n-gram pair combinations at operation 1724. The insight engine may then determine a targetvar_1 topic score (e.g., interest population n-gram pair combination score) and targetvar1 topic confidence (e.g., interest population n-gram pair combination confidence) for the n-gram pair combination at operation 1726. At operation 1728, the insight engine may determine whether the join the n-gram pairs of the n-gram pair combination into a single topic (e.g., topic identifier). The insight engine may then generate n-grams with n-gram counts in the targetvar_1 set 1730 (e.g., emerging topic subset with topic identifiers).

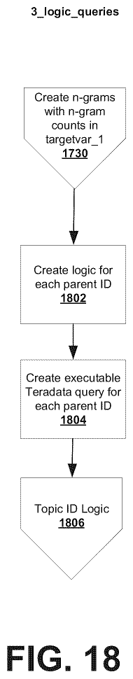

Turning now to FIG. 18, example operations of the 3_logic_queries routine 1310 are illustrated. The insight engine may create a logic for each topic identifier and further, create an executable Teradata query for each topic identifier. For example, the insight engine may determine whether a topic identifier associated with n-gram terms currently exists in a topic dictionary. At operation 1806, the insight engine may generate this topic logic.

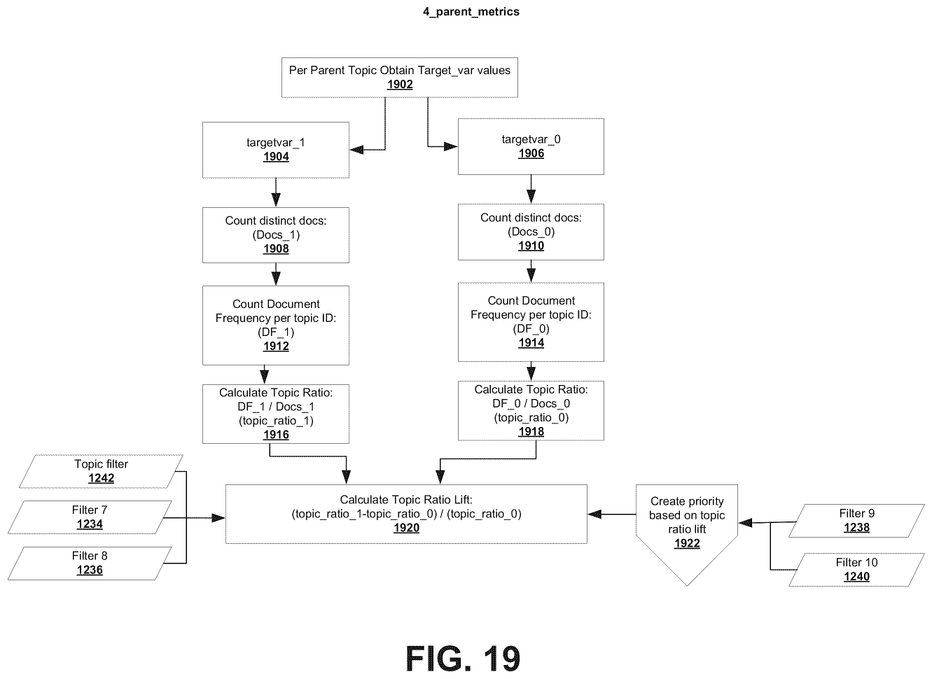

Turning now to FIG. 19, example operations of the 4_parent_metrics routine 1312 are illustrated. At operation 1902, the insight engine may select a topic (e.g., topic identifier). At operations 1904 and 1906, the insight engine may determine documents for targetvar_1 (e.g., interest population) for the topic identifier and documents for targetvar_0 (e.g., reference population) for the topic identifier, respectively. Then the insight engine may determine Docs_1 at operation 1908 (e.g., an interest population topic document count) and Docs_0 at operation 1910 (e.g., reference population topic document count) variables. The insight engine may also determine a DF_1 at operation 1912 (e.g., interest population topic frequency count) and a DF_0 at operation 1914 (e.g., reference population topic frequency count) for each topic. Then the insight engine may determine a topic_ratio_1 (e.g., interest population topic ratio) at operation 1916 and a topic_ratio_0 at operation 1918 (e.g., reference population topic ratio) for the topic identifiers. The insight engine may then calculate a topic ratio lift at operation 1920. The insight engine may apply a topic filter 1242, filter 7 1234, and filter 8 1236 to refine the topic identifiers included in the emerging topic set. The insight engine may also determine a priority for the topic identifiers at operation 1922 and may use filter 9 1238 and filter 10 1240 to refine the emerging topic set.

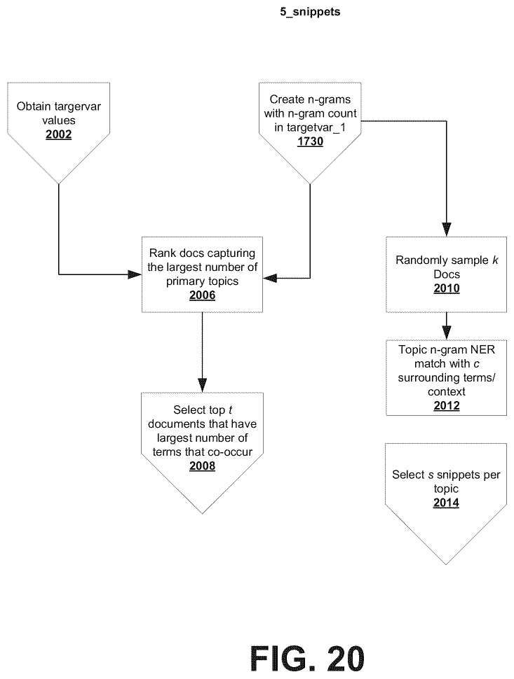

Turning now to FIG. 20, example operations of the 5_snippets routine 1314 are illustrated. At operation 2002, the insight engine may obtain the targetvar values (e.g., interest population topic document subset) and rank the documents based on the topic identifiers at operation 2006. The insight engine may select a set amount of t documents 2008 based on the number of n-gram terms that co-occur within the document. The insight engine may further also randomly sample a set number of k documents from an interest population at operation 2010 and may generate a snippet of the document at operation 2012. The insight engine may generate a count of s snippets for each topic identifier 2014.

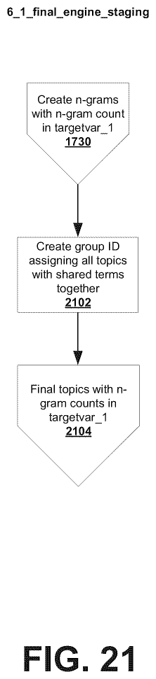

Turning now to FIG. 21, example operations of the 6_1_final_engine_staging routine 1316 are illustrated. At operation 2102, the insight engine may assign one or more topic identifiers a topic identifier if the topic identifiers share associated n-gram terms. The insight engine may include this as payload 2104.

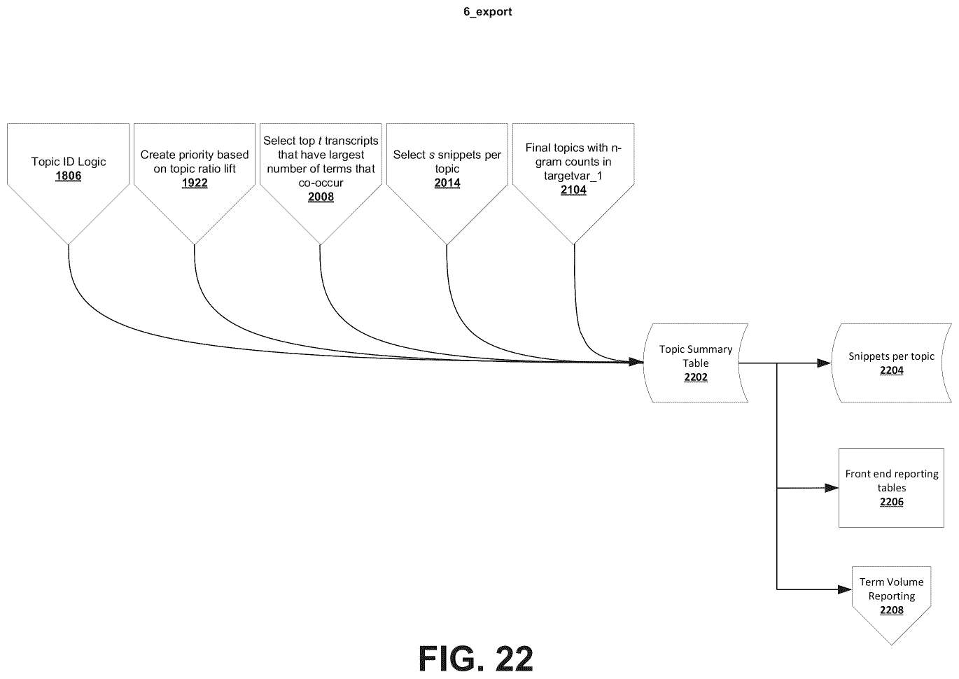

Turning now to FIG. 22, example operations of the 6_export routine 1318 are illustrated. At operation 2202, the insight engine may generate a summary table which includes metrics obtained from the various payload 1806, 1922, 2008, 2014, and 2104. The insight engine may also include snippets 2204 for each topic identifier. The insight engine may include the summary table 2202 and snippets 2204 in a front-end reporting table 2206 and during volume reporting operations 2208.

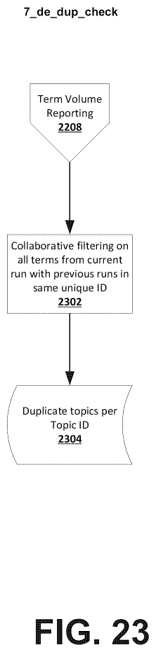

Turning now to FIG. 23, example operations of the 7_de_dup routine 1320 are illustrated. At operation 2302, the insight engine may filter the topic identifiers based on previous runs, such as runs stored in a topic dictionary. The insight engine may then de-duplicate topics based on the associated topic identifier and/or associated n-gram terms.

### CONCLUSION

As described above, example embodiments provide methods and apparatuses that enable analysis of emerging topics from within communication data. Example embodiments thus provide tools that overcome the problems faced by conventional methods of communication analysis, which requires manual review of individual communications. In contrast to these conventional techniques for communication evaluation, an insight engine may be used to automatically identify documents within a source document set that pertain to an interest population (e.g., communications occurring within a certain time frame and/or pertaining to certain types of entity users) and additionally may identify documents within the source document set that pertain to a reference population (e.g., communications occurring within a certain time frame and/or pertaining to certain types of entity users that is less restrictive than the interest population) without the need for manual intervention or review.

Accordingly, the present disclosure sets forth systems, methods, and apparatuses that may process documents (e.g., communications) pertaining to entity users of an entity in a time-efficient manner and further, allows for communications to be considered in aggregate such that issues affecting a population of interest may be identified. Additionally, embodiments described herein include filtering, deduplication, and/or combinational operations at various stages of the process such that operational resources may be conserved and future computational processing burden reduced. By automating this aggregate communication analysis that has historically required human analysis, the speed and consistency of the evaluations performed by example embodiments unlocks many potential new functions that have historically not been available, such as the ability to conduct near-real-time emerging issue evaluation and resolution.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for generating an insight report, the method comprising:
receiving, by communications hardware, a configured input data set, wherein the configured input data set comprises (i) a source document set and (ii) a configuration parameter set;
selecting, by an insight engine, an insight engine configuration based on the configuration parameter set;
generating, by the insight engine and based on the source document set, a n-gram term set;
performing, by the insight engine, a streamline n-gram routine on the n-gram term set;
generating, by the insight engine, an emerging topic set for an interest population, wherein the emerging topic set comprises one or more topic identifiers and each topic identifier is associated with one or more n-gram terms of the n-gram term set;
for each topic identifier included in the emerging topic set, generating, by the insight engine, a per-topic metric set, wherein the per-topic metric set comprises one or more per-topic metrics related to the one or more n-gram terms associated with the topic identifier;
generating, by the insight engine, the insight report, wherein the insight report comprises each per-topic metric set for each topic identifier included in the emerging topic set; and
providing, by the communications hardware, the insight report.

2. The method of claim 1, further comprising:
generating, by the insight engine, an interest population document subset from the source document set for the interest population, wherein the interest population document subset includes documents of the source document set which satisfy interest population criteria;
generating, by the insight engine, a reference population document subset from the source document set for a reference population, wherein the reference population document subset includes documents of the source document set which satisfy reference population criteria;
for each n-gram term included in the n-gram term set:
determining, by the insight engine, an interest population n-gram term ratio for the interest population,
determining, by the insight engine, a reference population n-gram term ratio for the reference population,
determining, by the insight engine and based on the interest population n-gram term ratio and the reference population n-gram term ratio, a n-gram ratio lift for the n-gram term, and
determining, by the insight engine and based on the n-gram ratio lift for the n-gram, a weighted n-gram ratio lift value for the n-gram term;
ranking, by the insight engine, each n-gram term included in the n-gram term set based on at least one of a n-gram ratio lift or weighted n-gram ratio lift associated with each n-gram term;
generating, by the insight engine and based on an associated n-gram term ranking, a n-gram term payload comprising one or more n-gram terms;
filtering, by the insight engine and based on one or more configuration parameters from the configuration parameter set, the one or more n-gram terms of the n-gram term payload; and
generating, by the insight engine, a topic identifier for each n-gram term of the n-gram term payload.

3. The method of claim 2, further comprising:
generating, by the insight engine and based on the n-gram term payload, an interest population relevant document subset, wherein the interest population relevant document subset comprises one or more documents of the interest population document subset which include a n-gram term of the n-gram term payload; and
generating, by the insight engine and based on the n-gram term payload, a reference population relevant document subset, wherein the reference population relevant document subset comprises one or more documents of the reference population document subset which include a n-gram term of the n-gram term payload.

4. The method of claim 3, further comprising:
generating, by the insight engine, a n-gram pair set, wherein (i) the n-gram pair set comprises one or more n-gram pairs and (ii) each n-gram pair includes a first n-gram term and a second n-gram term from the n-gram term payload;
for each n-gram pair included in the n-gram pair set:
determining, by the insight engine and based on the interest population relevant document subset, an interest population n-gram pair score,
determining, by the insight engine and based on the reference population relevant document subset, a reference population n-gram pair score,
determining, by the insight engine and based on the interest population relevant document subset, an interest population pair confidence,
determining, by the insight engine and based on the reference population relevant document subset, a reference population pair confidence,
determining, by the insight engine and based on the interest population n-gram pair score and the reference population n-gram pair score, a n-gram pair lift, and
determining, by the insight engine and based on the interest population pair confidence and the reference population pair confidence, a n-gram pair confidence lift;
ranking, by the insight engine, each n-gram pair included in the n-gram pair set based on at least one of an associated interest population n-gram pair score, an associated n-gram pair lift, or an associated n-gram pair confidence lift;
generating, by the insight engine and based on an associated n-gram pair ranking, a n-gram pair payload comprising one or more n-gram pairs;
filtering, by the insight engine and based on one or more configuration parameters from the configuration parameter set, the one or more n-gram pairs of the n-gram pair payload; and
generating, by the insight engine, a topic identifier for each n-gram pair of the n-gram pair payload.

5. The method of claim 4, further comprising:
generating, by the insight engine, a n-gram pair combination set, wherein (i) the n-gram pair combination set comprises one or more n-gram pair combinations and (ii) each n-gram pair combination includes a first n-gram pair and a second n-gram pair from the n-gram pair payload;
generating, by the insight engine, a first n-gram pair document subset, wherein the first n-gram pair document subset comprises one or more documents from at least the interest population document subset or the reference population document subset which include the first n-gram pair of the n-gram pair combination;
generating, by the insight engine, a second n-gram pair document subset, wherein the second n-gram pair document subset comprises one or more documents from at least the interest population document subset or the reference population document subset which include the second n-gram pair of the n-gram pair combination;
generating, by the insight engine, an overlap n-gram pair document subset, wherein the overlap n-gram pair document set comprises one or more documents which are included in both the first n-gram pair document subset and the second n-gram pair document subset;
generating, by the insight engine, an interest population overlap n-gram pair combination document subset, wherein the interest population overlap n-gram pair combination document subset includes documents of the overlap n-gram pair document subset which satisfy interest population criteria;
generating, by the insight engine, a reference population overlap n-gram pair combination document subset, wherein the reference population overlap n-gram pair combination document subset includes documents of the overlap n-gram pair document subset which satisfy reference population criteria.

6. The method of claim 5, further comprising:
for each n-gram pair combination included in the n-gram pair combination payload:
determining, by the insight engine, an interest population n-gram pair combination ratio for the interest population,
determining, by the insight engine, a reference population n-gram pair combination ratio for the reference population,
determining, by the insight engine and based on the interest population n-gram pair combination ratio and the reference population pair combination ratio, a n-gram pair combination lift for the n-gram pair combination, and
determining, by the insight engine and based on the n-gram pair combination lift, whether one or more n-gram pair combination thresholds are satisfied.

7. The method of claim 6, further comprising:
in an instance the one or more n-gram pair combination thresholds are satisfied:
determining, by the insight engine, an interest population n-gram pair combination score,
determining, by the insight engine, an interest population n-gram pair combination confidence,
determining, by the insight engine and based on at least one of the interest population n-gram pair combination score or the interest population n-gram pair combination confidence, whether one or more topic thresholds are satisfied, and
in an instance the one or more topic thresholds are satisfied, generating a topic identifier for the n-gram pair combination.

8. The method of claim 1, further comprising:
for each topic identifier included in the emerging topic set:
generating, by the insight engine, an interest population topic document subset from the source document set for the interest population, wherein the interest population topic document subset includes documents of an interest population document subset which include one or more n-gram terms associated with the topic identifier;
generating, by the insight engine, a reference population topic document subset from the source document set for the reference population, wherein the reference population topic document subset includes documents of a reference population document subset which include one or more n-gram terms associated with the topic identifier;
determining, by the insight engine, an interest population topic ratio for the interest population,
determining, by the insight engine, a reference population topic ratio for the reference population, and
determining, by the insight engine and based on the interest population topic ratio and the reference population topic ratio, a topic ratio lift for the topic identifier, wherein each topic identifier included in the emerging topic set is ordered based on an associated topic ratio lift.

9. The method of claim 1, further comprising:
for each topic identifier included in the emerging topic set:
generating, by the insight engine, an interest population topic document subset from the source document set for the interest population, wherein the interest population topic document subset includes documents of an interest population document subset which include one or more n-gram terms associated with the topic identifier, and
generating, by the insight engine, one or more topic context snippets from a document included in the interest population topic document subset, wherein the topic context snippet comprises a n-gram term associated with the topic identifier and at least one or more preceding terms or one or more succeeding terms.

10. The method of claim 1, further comprising:
for each topic identifier included in the emerging topic set:
generating, by the insight engine, an interest population topic document subset from the source document set for the interest population, wherein the interest population topic document subset includes documents of an interest population document subset which include one or more n-gram terms associated with the topic identifier, and
selecting, by the insight engine, one or more documents from the interest population topic document subset in which a n-gram term associated with the topic identifier appears most frequently.

11. The method of claim 1, further comprising assigning, by the insight engine, a group identifier to two or more topic identifiers included in the emerging topic set, wherein the group identifier is assigned to topic identifiers which include one or more of same associated n-gram terms.

12. An apparatus for generating an insight report, the apparatus comprising:
communications hardware configured to receive a configured input data set, wherein the configured input data set comprises (i) a source document set and (ii) a configuration parameter set; and
an insight engine configured to:
select an insight engine configuration based on the configuration parameter set,
generate, based on the source document set, a n-gram term set,
perform a streamline n-gram routine on the n-gram term set,
generate an emerging topic set for an interest population, wherein the emerging topic set comprises one or more topic identifiers and each topic identifier is associated with one or more n-gram terms of the n-gram term set,
for each topic identifier included in the emerging topic set, generate a per-topic metric set, wherein the per-topic metric set comprises one or more per-topic metrics related to the one or more n-gram terms associated with the topic identifier, and
generate an insight report, wherein the insight report comprises each per-topic metric set for each topic identifier included in the emerging topic set,
wherein the communications hardware is further configured to provide the insight report.

13. The apparatus of claim 12, wherein the insight engine is further configured to:
generate an interest population document subset from the source document set for the interest population, wherein the interest population document subset includes documents of the source document set which satisfy interest population criteria;
generate a reference population document subset from the source document set for a reference population, wherein the reference population document subset includes documents of the source document set which satisfy reference population criteria;
for each n-gram term included in the n-gram term set:
determine an interest population n-gram term ratio for the interest population,
determine a reference population n-gram term ratio for the reference population,
determine, based on the interest population n-gram term ratio and the reference population n-gram term ratio, a n-gram ratio lift for the n-gram term, and
determine, based on the n-gram ratio lift for the n-gram, a weighted n-gram ratio lift value for the n-gram term;
rank each n-gram term included in the n-gram term set based on at least one of a n-gram ratio lift or weighted n-gram ratio lift associated with each n-gram term;
generate, based on an associated n-gram term ranking, a n-gram term payload comprising one or more n-gram terms;
filter, based on one or more configuration parameters from the configuration parameter set, the one or more n-gram terms of the n-gram term payload; and
generate a topic identifier for each n-gram term of the n-gram term payload.

14. The apparatus of claim 13, wherein the insight engine is further configured to:
generate, based on the n-gram term payload, an interest population relevant document subset, wherein the interest population relevant document subset comprises one or more documents of the interest population document subset which include a n-gram term of the n-gram term payload; and
generate, based on the n-gram term payload, a reference population relevant document subset, wherein the reference population relevant document subset comprises one or more documents of the reference population document subset which include a n-gram term of the n-gram term payload.

15. The apparatus of claim 14, wherein the insight engine is further configured to:
generate a n-gram pair set, wherein (i) the n-gram pair set comprises one or more n-gram pairs and (ii) each n-gram pair includes a first n-gram term and a second n-gram term from the n-gram term payload;
for each n-gram pair included in the n-gram pair set:
determine, based on the interest population relevant document subset, an interest population n-gram pair score,
determine, based on the reference population relevant document subset, a reference population n-gram pair score,
determine, based on the interest population relevant document subset, an interest population pair confidence,
determine, based on the reference population relevant document subset, a reference population pair confidence,
determine, based on the interest population n-gram pair score and the reference population n-gram pair score, a n-gram pair lift, and
determine, based on the interest population pair confidence and the reference population pair confidence, a n-gram pair confidence lift;
rank each n-gram pair included in the n-gram pair set based on at least one of an associated interest population n-gram pair score, an associated n-gram pair lift, or an associated n-gram pair confidence lift;
generate, based on an associated n-gram pair ranking, a n-gram pair payload comprising one or more n-gram pairs;
filter, based on one or more configuration parameters from the configuration parameter set, the one or more n-gram pairs of the n-gram pair payload; and
generate a topic identifier for each n-gram pair of the n-gram pair payload.

16. The apparatus of claim 15, wherein the insight engine is further configured to:
generate a n-gram pair combination set, wherein (i) the n-gram pair combination set comprises one or more n-gram pair combinations and (ii) each n-gram pair combination includes a first n-gram pair and a second n-gram pair from the n-gram pair payload;
generate a first n-gram pair document subset, wherein the first n-gram pair document subset comprises one or more documents from at least the interest population document subset or the reference population document subset which include the first n-gram pair of the n-gram pair combination;
generate a second n-gram pair document subset, wherein the second n-gram pair document subset comprises one or more documents from at least the interest population document subset or the reference population document subset which include the second n-gram pair of the n-gram pair combination;
generate an overlap n-gram pair document subset, wherein the overlap n-gram pair document set comprises one or more documents which are included in both the first n-gram pair document subset and the second n-gram pair document subset;
generate an interest population overlap n-gram pair combination document subset, wherein the interest population overlap n-gram pair combination document subset includes documents of the overlap n-gram pair document subset which satisfy interest population criteria; and
generate a reference population overlap n-gram pair combination document subset, wherein the reference population overlap n-gram pair combination document subset includes documents of the overlap n-gram pair document subset which satisfy reference population criteria.

17. The apparatus of claim 16, wherein the insight engine is further configured to:
for each n-gram pair combination included in the n-gram pair combination payload:
determine an interest population n-gram pair combination ratio for the interest population,
determine a reference population n-gram pair combination ratio for the reference population,
determine, based on the interest population n-gram pair combination ratio and the reference population pair combination ratio, a n-gram pair combination lift for the n-gram pair combination, and
determine, based on the n-gram pair combination lift, whether one or more n-gram pair combination thresholds are satisfied.

18. The apparatus of claim 17, wherein the insight engine is further configured to:
in an instance the one or more n-gram pair combination thresholds are satisfied:
determine an interest population n-gram pair combination score,
determine an interest population n-gram pair combination confidence,
determine, based on at least one of the interest population n-gram pair combination score or the interest population n-gram pair combination confidence, whether one or more topic thresholds are satisfied, and
in an instance the one or more topic thresholds are satisfied, generate a topic identifier for the n-gram pair combination.

19. The apparatus of claim 12, wherein the insight engine is further configured to, for each topic identifier included in the emerging topic set:
generate an interest population topic document subset from the source document set for the interest population, wherein the interest population topic document subset includes documents of an interest population document subset which include one or more n-gram terms associated with the topic identifier;
generate an interest population topic document subset from the source document set for the interest population, wherein the interest population topic document subset includes documents of an interest population document subset which include one or more n-gram terms associated with the topic identifier;
determine an interest population topic ratio for the interest population;
determine a reference population topic ratio for the reference population; and
determine, based on the interest population topic ratio and the reference population topic ratio, a topic ratio lift for the topic identifier, wherein each topic identifier included in the emerging topic set is ordered based on an associated topic ratio lift.

20. A computer program product for generating an insight report, the computer program product comprising at least one non-transitory computer-readable storage medium storing software instructions that, when executed, cause an apparatus to:
receive a configured input data set, wherein the configured input data set comprises (i) a source document set and (ii) a configuration parameter set;
select an insight engine configuration based on the configuration parameter set;
generate, based on the source document set, a n-gram term set;
perform a streamline n-gram routine on the n-gram term set;
generate an emerging topic set for an interest population, wherein the emerging topic set comprises one or more topic identifiers and each topic identifier is associated with one or more n-gram terms of the n-gram term set;
for each topic identifier included in the emerging topic set, generate a per-topic metric set, wherein the per-topic metric set comprises one or more per-topic metrics related to the one or more n-gram terms associated with the topic identifier;
generate an insight report, wherein the insight report comprises each per-topic metric set for each topic identifier included in the emerging topic set; and
provide the insight report.
